(19) United States
(12) Patent Application Publication
(10) Pub. No.: US 2018/0288703 A1
(43) Pub. Date: Oct. 4, 2018

(54) POWER STATE MANAGEMENT OF A WIRELESS DEVICE EQUIPPED WITH WAKEUP RADIO

(71) Applicant: QUALCOMM Incorporated, San Diego, CA (US)

(72) Inventors: Yanjun Sun, San Diego, CA (US); George Cherian, San Diego, CA (US); Alfred Asterjadhi, San Diego, CA (US)

(21) Appl. No.: 15/936,716

(22) Filed: Mar. 27, 2018

Related U.S. Application Data
(60) Provisional application No. 62/477,700, filed on Mar. 28, 2017.

(51) Int. Cl. H04W 52/02; H04W 76/27

(52) U.S. Cl. CPC H04W 52/0229; H04W 84/12; H04W 76/27

(57) ABSTRACT

A wireless device may identify a transition from use of a main radio to use of a wakeup radio (WUR) of the wireless device is to occur. The wireless device may store the power state the main radio is operating in at the time of the transition. The wireless device may then power down the main radio and power up the WUR to perform the transition. Upon a transition back to use of the main radio from use of the WUR (e.g., in response to a wakeup transmission), the wireless device may power down the WUR and power up the main radio to the stored power state. Additionally, the wireless device may further store WUR power state information, such that upon exit and reentry of WUR operation, the wireless device may resume a previously used WUR power mode. Modified or newly defined uplink frames may indicate such power state transitions.

### CROSS REFERENCES

The present application for patent claims priority to U.S. Provisional Patent Application No. 62/477,700 by SUN, et al., entitled “Power State Management of a Wireless Device Equipped With Wakeup Radio,” filed Mar. 28, 2017, assigned to the assignee hereof.

### BACKGROUND

The following relates generally to wireless communication, and more specifically to power state management of a wireless device equipped with a wakeup radio (WUR).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A wireless device may have a limited amount of battery power. In some cases, it may be beneficial for a primary radio (e.g., of a wireless device) to remain in a sleep mode or low power mode for extended periods of time. During a sleep mode, a wireless device may periodically activate a radio, such as a wakeup radio (which may also be referred to as a WUR or wakeup receiver), to listen for and decode a wakeup signal (e.g., wakeup transmissions or wakeup frames) from an AP. The wireless device may then power on a primary radio of the wireless device in response to receiving the wakeup signal from an AP. A primary radio may operate in one of multiple predefined power states (e.g., active state, legacy power save state, unscheduled automatic power save deliver (U-APSD), etc.). Improved techniques for transitioning between power states of a primary radio (e.g., a main radio) and a WUR may be desired.

### SUMMARY

The described techniques relate to improved methods, systems, devices, or apparatuses that support power state management of a wireless device equipped with a wakeup radio (WUR). Generally, the described techniques provide for storage and resumption of power states (e.g., suspending of power states) associated with main radios and WURs. A wireless device may identify that a transition from use of a main radio to use of a WUR of the wireless device is to occur. The wireless device may store the power state the main radio is operating in at the time of the transition. The wireless device may then power down the main radio and power up the WUR to perform the transition. Upon a transition back to use of the main radio from use of the WUR (e.g., in response to a wakeup transmission), the wireless device may power down the WUR and power up the main radio to the stored power state (e.g., according to maintained main radio parameters). Additionally, the wireless device may further store WUR power state information, such that upon exit and reentry of WUR operation, the wireless device may resume a previously used WUR power mode (e.g., according to maintained WUR parameters). Modified or newly defined uplink frames may indicate such power state transitions.

A method of wireless communication is described. The method may include identifying that a first transition from use of a main radio of the wireless station to use of a wakeup radio of the wireless station is to occur, and storing, at the wireless station, a power state of the main radio at a time of the first transition. The method may include powering down the main radio and powering up the wakeup radio to perform the first transition from use of the main radio to use of the wakeup radio. The method may further include powering up the main radio to the stored power state and powering down the wakeup radio to perform a second transition from use of the wakeup radio to use of the main radio.

An apparatus for wireless communication is described. The apparatus may include means for identifying that a first transition from use of a main radio of the wireless station to use of a wakeup radio of the wireless station is to occur, and means for storing, at the wireless station, a power state of the main radio at a time of the first transition. The apparatus may include means for powering down the main radio and powering up the wakeup radio to perform the first transition from use of the main radio to use of the wakeup radio. The apparatus may further include means for powering up the main radio to the stored power state and powering down the wakeup radio to perform a second transition from use of the wakeup radio to use of the main radio.

Another apparatus for wireless communication is described. The apparatus may include a processor, memory in electronic communication with the processor, and instructions stored in the memory. The instructions may be operable to cause the processor to identify that a first transition from use of a main radio of the wireless station to use of a wakeup radio of the wireless station is to occur, and store, at the wireless station, a power state of the main radio at a time of the first transition. The instructions may be operable to cause the processor to power down the main radio and powering up the wakeup radio to perform the first transition from use of the main radio to use of the wakeup radio. The instructions may be further operable to cause the processor to and power up the main radio to the stored power state and powering down the wakeup radio to perform a second transition from use of the wakeup radio to use of the main radio.

A non-transitory computer readable medium for wireless communication is described. The non-transitory computer-readable medium may include instructions operable to cause a processor to identify that a first transition from use of a main radio of the wireless station to use of a wakeup radio of the wireless station is to occur, store, at the wireless station, a power state of the main radio at a time of the first transition, power down the main radio and powering up the wakeup radio to perform the first transition from use of the main radio to use of the wakeup radio, and power up the main radio to the stored power state and powering down the wakeup radio to perform a second transition from use of the wakeup radio to use of the main radio.

Some examples of the method, apparatus, and non-transitory computer-readable medium described above may further include processes, features, means, or instructions for determining a new power state of the main radio for operation after the second transition.

Some examples of the method, apparatus, and non-transitory computer-readable medium described above may further include processes, features, means, or instructions for receiving a wakeup frame to trigger the second transition, wherein the wakeup frame includes an indication of a new power state of the main radio for operation. Some examples of the method, apparatus, and non-transitory computer-readable medium described above may further include processes, features, means, or instructions for transitioning the main radio from the stored power state to the new power state after the second transition.

Some examples of the method, apparatus, and non-transitory computer-readable medium described above may further include processes, features, means, or instructions for indicating a power-on delay interval to an access point (AP), the power-on delay interval representing a minimum amount of time between transmission, by the AP, of a wakeup frame to the wakeup radio and transmission, by the AP, to the main radio. Some examples of the method, apparatus, and non-transitory computer-readable medium described above may further include processes, features, means, or instructions for transmitting, by the main radio, a transition signal to an AP in order to indicate to the AP that the wireless station may be to undergo the first transition.

Some examples of the method, apparatus, and non-transitory computer-readable medium described above may further include processes, features, means, or instructions for transmitting, by the main radio, a transition indication in an uplink frame to an AP, the transition indication indicating to the AP that the wireless station may be to undergo the first transition. In some examples of the method, apparatus, and non-transitory computer-readable medium described above, the uplink frame may be any one of an acknowledgement, a block acknowledgement, a data frame, an action frame, or a management frame. In some examples of the method, apparatus, and non-transitory computer-readable medium described above, the transition indication may be a single bit reserved in the uplink frame for indicating the first transition.

Some examples of the method, apparatus, and non-transitory computer-readable medium described above may further include processes, features, means, or instructions for negotiating, with an AP, a predetermined timeout parameter such that the AP may be aware that the wireless station will undergo the first transition in accordance to the predetermined timeout parameter. Some examples of the method, apparatus, and non-transitory computer-readable medium described above may further include processes, features, means, or instructions for transmitting, by the main radio, a packet so as to indicate to an AP that the wireless station may have undergone the second transition. Some examples of the method, apparatus, and non-transitory computer-readable medium described above may further include processes, features, means, or instructions for transmitting, by the main radio, a transition signal to an AP in order to indicate to the AP that the wireless station may have undergone the second transition.

Some examples of the method, apparatus, and non-transitory computer-readable medium described above may further include processes, features, means, or instructions for storing, at the wireless station, a power state of the wakeup radio at the time of the second transition. Some examples of the method, apparatus, and non-transitory computer-readable medium described above may further include processes, features, means, or instructions for powering down the main radio and powering up the wakeup radio to the stored power state of the wakeup radio to perform a third transition from use of the main radio to use of the wakeup radio.

In some examples of the method, apparatus, and non-transitory computer-readable medium described above, the power state of the wakeup radio comprises a duty cycle schedule, a wakeup radio channel, a wakeup radio identification assignment, a group assignment, a security key, or some combination thereof. In some examples of the method, apparatus, and non-transitory computer-readable medium described above, storing the power state of the main radio at the time of the first transition includes storing one or more of a power mode of the main radio or an operating parameter of the main radio, where the operating parameter includes an indication of an existing service period negotiated between the wireless station and a network. Further, powering down the main radio may include suspending the existing service period associated with the main radio of the wireless station.

A method of wireless communication is described. The method may include identifying that a first transition from use of a main radio of the wireless station to use of a wakeup radio of the wireless station is to occur. The method may include powering down the main radio and powering up the wakeup radio to perform the first transition from use of the main radio to use of the wakeup radio. The method may include powering up the main radio to the stored power state and powering down the wakeup radio to perform a second transition from use of the wakeup radio to use of the main radio. The method may further include indicating to an AP that at least one of the first transition or second transition has occurred.

An apparatus for wireless communication is described. The apparatus may include means for identifying that a first transition from use of a main radio of the wireless station to use of a wakeup radio of the wireless station is to occur. The apparatus may include means for powering down the main radio and powering up the wakeup radio to perform the first transition from use of the main radio to use of the wakeup radio. The apparatus may include means for powering up the main radio to the stored power state and powering down the wakeup radio to perform a second transition from use of the wakeup radio to use of the main radio. The apparatus may further include means for indicating to an AP that at least one of the first transition or second transition has occurred.

Another apparatus for wireless communication is described. The apparatus may include a processor, memory in electronic communication with the processor, and instructions stored in the memory. The instructions may be operable to cause the processor to identify that a first transition from use of a main radio of the wireless station to use of a wakeup radio of the wireless station is to occur. The instructions may be operable to cause the processor to power down the main radio and power up the wakeup radio to perform the first transition from use of the main radio to use of the wakeup radio. The instructions may be operable to cause the processor to power up the main radio to the stored power state and power down the wakeup radio to perform a second transition from use of the wakeup radio to use of the main radio. The instructions may be further operable to cause the processor to indicate to an AP that at least one of the first transition or second transition has occurred.

A non-transitory computer readable medium for wireless communication is described. The non-transitory computer-readable medium may include instructions operable to cause a processor to identify that a first transition from use of a main radio of the wireless station to use of a wakeup radio of the wireless station is to occur. The non-transitory computer-readable medium may include instructions operable to cause a processor to power down the main radio and power up the wakeup radio to perform the first transition from use of the main radio to use of the wakeup radio. The non-transitory computer-readable medium may include instructions operable to cause a processor to power up the main radio to the stored power state and power down the wakeup radio to perform a second transition from use of the wakeup radio to use of the main radio. The non-transitory computer-readable medium may include instructions further operable to cause a processor to indicate to an AP that at least one of the first transition or second transition has occurred.

In some examples of the method, apparatus, and non-transitory computer-readable medium described above, indicating that at least one of the first transition or second transition may have occurred comprises transmitting, by the main radio, a transition signal to the AP to indicate that either the first transition or the second transition occurred. In some examples of the method, apparatus, and non-transitory computer-readable medium described above, indicating that at least one of the first transition or second transition may have occurred comprises transmitting, by the main radio, a transition indication in an uplink frame to the AP to indicate that the first transition occurred.

In some examples of the method, apparatus, and non-transitory computer-readable medium described above, the uplink frame may be any one of an acknowledgement, a block acknowledgement, a data frame, an action frame, or a management frame. In some examples of the method, apparatus, and non-transitory computer-readable medium described above, the transition indication may be a single bit reserved in the uplink frame for indicating the first transition. In some examples of the method, apparatus, and non-transitory computer-readable medium described above, indicating that at least one of the first transition or second transition may have occurred comprises negotiating, with the AP, a predetermined timeout parameter such that the AP may be aware that the first transition will occur in accordance to the predetermined timeout parameter.

In some examples of the method, apparatus, and non-transitory computer-readable medium described above, indicating that at least one of the first transition or second transition may have occurred comprises transmitting, by the main radio, a packet so as to indicate to the AP that the second transition occurred. Some examples of the method, apparatus, and non-transitory computer-readable medium described above may further include processes, features, means, or instructions for indicating a power-on delay interval to the AP, the power-on delay interval representing a minimum amount of time between transmission, by the AP, of a wakeup frame to the wakeup radio and transmission, by the AP, to the main radio. Some examples of the method, apparatus, and non-transitory computer-readable medium described above may further include processes, features, means, or instructions for receiving a transmission at the main radio from the AP in accordance with the power-on delay interval.

A method of wireless communication is described. The method may include receiving an indication from the wireless station that at least one of a first transition or a second transition has occurred, wherein the first transition is a powering down of the main radio of the wireless station and a powering up of the wakeup radio of the wireless station, and wherein the second transition is a powering up of the main radio of the wireless station and a powering down of the wakeup radio of the wireless station and transmitting a frame to either the main radio or the wakeup radio, in accordance with the indication.

An apparatus for wireless communication is described. The apparatus may include means for receiving an indication from the wireless station that at least one of a first transition or a second transition has occurred, wherein the first transition is a powering down of the main radio of the wireless station and a powering up of the wakeup radio of the wireless station, and wherein the second transition is a powering up of the main radio of the wireless station and a powering down of the wakeup radio of the wireless station and means for transmitting a frame to either the main radio or the wakeup radio, in accordance with the indication.

Another apparatus for wireless communication is described. The apparatus may include a processor, memory in electronic communication with the processor, and instructions stored in the memory. The instructions may be operable to cause the processor to receive an indication from the wireless station that at least one of a first transition or a second transition has occurred, wherein the first transition is a powering down of the main radio of the wireless station and a powering up of the wakeup radio of the wireless station, and wherein the second transition is a powering up of the main radio of the wireless station and a powering down of the wakeup radio of the wireless station and transmit a frame to either the main radio or the wakeup radio, in accordance with the indication.

A non-transitory computer readable medium for wireless communication is described. The non-transitory computer-readable medium may include instructions operable to cause a processor to receive an indication from the wireless station that at least one of a first transition or a second transition has occurred, wherein the first transition is a powering down of the main radio of the wireless station and a powering up of the wakeup radio of the wireless station, and wherein the second transition is a powering up of the main radio of the wireless station and a powering down of the wakeup radio of the wireless station and transmit a frame to either the main radio or the wakeup radio, in accordance with the indication.

In some examples of the method, apparatus, and non-transitory computer-readable medium described above, receiving the indication that at least one of the first transition or second transition may have occurred comprises receiving a transition signal indicating that either the first transition or the second transition occurred. In some examples of the method, apparatus, and non-transitory computer-readable medium described above, receiving the indication that at least one of the first transition or second transition may have occurred comprises receiving a transition indication in an uplink frame indicating that the first transition occurred. In some examples of the method, apparatus, and non-transitory computer-readable medium described above, the uplink frame may be any one of an acknowledgement, a block acknowledgement, a data frame, an action frame, or a management frame. In some examples of the method, apparatus, and non-transitory computer-readable medium described above, the transition indication may be a single bit reserved in the uplink frame for indicating the first transition.

In some examples of the method, apparatus, and non-transitory computer-readable medium described above, receiving the indication that at least one of the first transition or second transition may have occurred comprises negotiating, with the wireless station, a predetermined timeout parameter such that the AP may be aware that the first transition will occur in accordance to the predetermined timeout parameter. In some examples of the method, apparatus, and non-transitory computer-readable medium described above, receiving the indication that at least one of the first transition or second transition may have occurred comprises receiving a packet from the main radio of the wireless station.

Some examples of the method, apparatus, and non-transitory computer-readable medium described above may further include processes, features, means, or instructions for receiving a power-on delay interval indication from the wireless station, the power-on delay interval indication representing a minimum amount of time between transmission, by the AP, of a wakeup frame to the wakeup radio of the wireless station and transmission, by the AP, to the main radio of the wireless station. Some examples of the method, apparatus, and non-transitory computer-readable medium described above may further include processes, features, means, or instructions for transmitting a frame to the main radio of the wireless station in accordance to the power-on delay interval indication. Some examples of the method, apparatus, and non-transitory computer-readable medium described above may further include processes, features, means, or instructions for transmitting a wakeup frame to trigger the second transition, wherein the wakeup frame includes an indication of a new power state of the main radio for operation to be used by the wireless station.

### BRIEF DESCRIPTION OF THE DRAWINGS

FIG. 1 illustrates an example of a system for wireless communication that supports power state management of a wireless device equipped with a wakeup radio (WUR) in accordance with aspects of the present disclosure.

FIG. 2 illustrates an example of a wireless communications system that supports power state management of a wireless device equipped with a WUR in accordance with aspects of the present disclosure.

FIG. 3 illustrates an example of a power state transition scheme that supports power state management of a wireless device equipped with a WUR in accordance with aspects of the present disclosure.

FIG. 4 illustrates an example of a process flow that supports power state management of a wireless device equipped with a WUR in accordance with aspects of the present disclosure.

FIGS. 5 through 7 show block diagrams of a device that supports power state management of a wireless device equipped with a WUR in accordance with aspects of the present disclosure.

FIG. 8 illustrates a block diagram of a system including a station (STA) that supports power state management of a wireless device equipped with a WUR in accordance with aspects of the present disclosure.

FIGS. 9 through 11 show block diagrams of a device that supports power state management of a wireless device equipped with a WUR in accordance with aspects of the present disclosure.

FIG. 12 illustrates a block diagram of a system including an access point (AP) that supports power state management of a wireless device equipped with a WUR in accordance with aspects of the present disclosure.

FIGS. 13 through 17 illustrate methods for power state management of a wireless device equipped with a WUR in accordance with aspects of the present disclosure.

### DETAILED DESCRIPTION

A wireless device may have a limited amount of battery power. In some cases, it may be beneficial for a primary radio (e.g., of a wireless device) to remain in a sleep mode or low power mode for extended periods of time. During a sleep mode, a wireless device may periodically activate a low-power radio (e.g., a wakeup radio (WUR)) to listen for and decode a wakeup signal (e.g., wakeup transmissions) from an access point (AP), to trigger activation of the primary radio. Power state management for wireless devices operating multiple radios (e.g., a WUR and a main radio) may be associated with increased complexity. For example, each radio may operate according to multiple power states (e.g., based on power limitations, pending traffic, etc.). That is, power management for such wireless devices may include management of transitions between power states associated with each radio, in addition to management of transitions between power states of different radios.

Power state transitions may be defined for transitions from a main radio to a WUR and vice versa. Power states of both the main radio and the WUR may be preserved (e.g., suspended) and resumed during transitions between radios, or during transitions between power states of an individual radio. Freezing or preserving a power state may refer to storing or saving of power modes and/or associated operation parameters (e.g., time windows defined in target wake time (TWT) operation, number of frames a single trigger can retrieve in unscheduled automatic power save delivery (U-APSD), WUR duty-cycle, WUR channel, a negotiated main radio schedule, etc.). Such information may be preserved (e.g., negotiated WUR parameters, main radio schedules, etc., between the AP and the STA may be maintained or suspended) for increased power state flexibility and improved power state transition management.

For example, upon a transition to operation of the WUR, the power state of the main radio (e.g., main radio operation parameters) may be frozen or preserved such that, upon a transition back to operation of the main radio, the previous main radio power state may be resumed (e.g., all power states may be preserved on the main radio). That is, when a wireless device transitions to operation of the WUR, the main radio may store the power state prior to entering a deep sleep state. Upon resumption of main radio operation (e.g., when a wakeup transmission is received on the WUR) the main radio may return to the previously stored power state. Additionally, a wireless device may operate a WUR according to some parameters (e.g., duty-cycle, WUR channel, etc.), and the wireless device may elect to store such power state information prior to transition to main radio operation, such that WUR operation may then resume as before upon a transition back from the main radio to the WUR.

As such, a wireless device client may selectively choose which power state to resume on the main radio after a transition to the WUR. That is, a wireless device may transition to the main radio power state it wishes to later resume on the main radio, such that after a wakeup transmission is received on the WUR (e.g., during WUR operation post transition from the main radio), the wireless device may transition back to the desired power state on the main radio (e.g., that was frozen or preserved). Additionally, a wireless device may determine when to maintain a WUR power state (e.g., WUR operation parameters) or when to renegotiate WUR operation parameters upon transitioning back into WUR operation.

Aspects of the disclosure introduced above are described below in the context of a wireless communications system. Example power state transitions schemes and process flows exemplifying power state management techniques are then described. Aspects of the disclosure are further illustrated by and described with reference to apparatus diagrams, system diagrams, and flowcharts that relate to power state management of a wireless device equipped with a WUR.

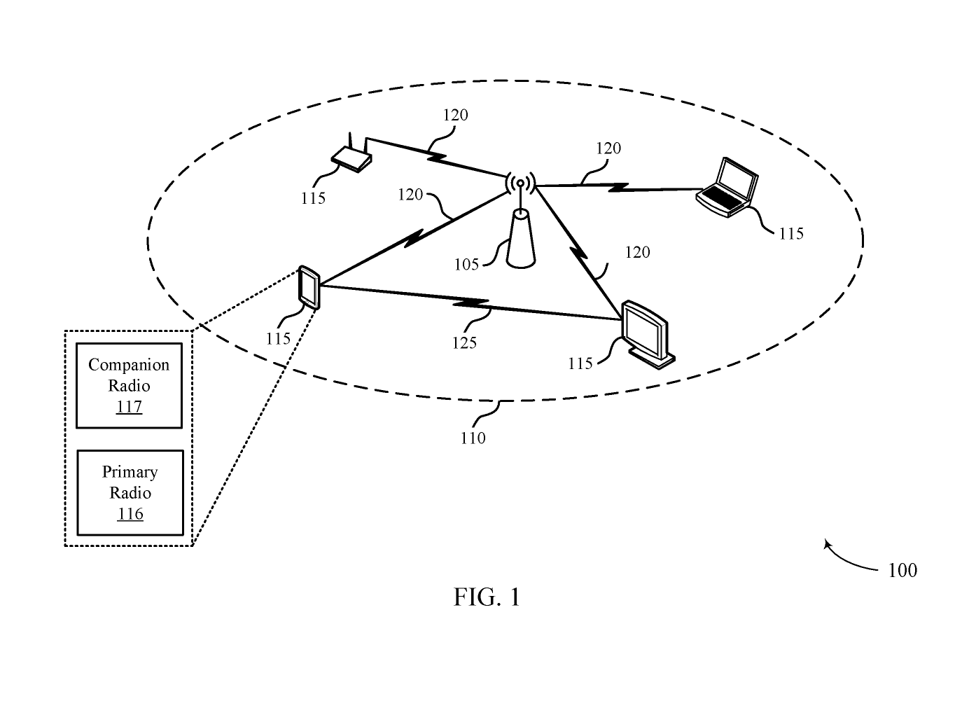

FIG. 1 illustrates a wireless local area network (WLAN) 100 (also known as a Wi-Fi network) configured in accordance with various aspects of the present disclosure. The WLAN 100 may include an AP 105 and multiple associated stations (STAs) 115, which may represent devices such as wireless communication terminals, including mobile stations, phones personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS. WLAN 100 may support media access control for wakeup radio.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc.

In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands, such as shared licensed frequency bands, where multiple operators may have a license to operate in the same or overlapping frequency band or bands.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

A STA 115 may include a primary radio 116 and a low power companion radio 117 for communication. The primary radio 116 may be used during active modes (e.g., full power modes) or for high-data throughput applications. A low-power companion radio 117 may be used during low-power modes or for low-throughput applications. In some examples, the low-power companion radio 117 may be a WUR or a wakeup receiver radio.

A STA 115 may listen using a WUR, such as companion radio 117, for a wakeup message or wakeup frame in a wakeup waveform. In some cases, STA 115 may receive a preamble having a first frequency band (e.g., wideband, such as on a 20 MHz channel) and a wakeup signal (e.g., a WUR signal) having a second frequency band (e.g., narrowband, such as a 4-5 MHz channel within the 20 MHz channel). Further, the companion radio 117 may share the same medium (e.g., frequency spectrum targeted for reception) as primary radio 116. However, transmissions intended for companion radio 117 may be associated with lower data rates (e.g., tens or hundreds of kbps).

Transitions may be defined for power state transitions from a main radio to a WUR and vice versa. Power states of both the main radio and the WUR may be preserved (e.g., stored) and resumed during transitions between radios, or during transitions between power states of an individual radio. Freezing or preserving a power state may refer to storing or saving of power modes and/or associated operation parameters (e.g., time windows defined in TWT operation, number of frames a single trigger can retrieve in U-APSD, WUR duty-cycle, WUR channel, etc.). Such information may be preserved for increased power state flexibility and improved power state transition management within WLAN 100. For example, in a WUR mode, an STA 115 may operate a WUR (e.g., a companion radio 117) according to a duty cycle schedule agreed upon between the STA 115 and the AP 105 (e.g., if the STA is in the doze state). The existing negotiated service period between the AP 105 and the main radio schedule of STA 115 (e.g., TWT, operational service period, schedule for sleep mode, etc.) may be suspended. The STA 115 may not be required to wake up during the service period if the service period is suspended. The parameters of the negotiated service period (e.g., one or more operating parameters that include an indication of an existing service period negotiated between the wireless station and a network) for the STA 115 main radio schedule may be saved by the AP 105 and the STA 115 when the negotiated service period is suspended (e.g., when the main radio is powered.

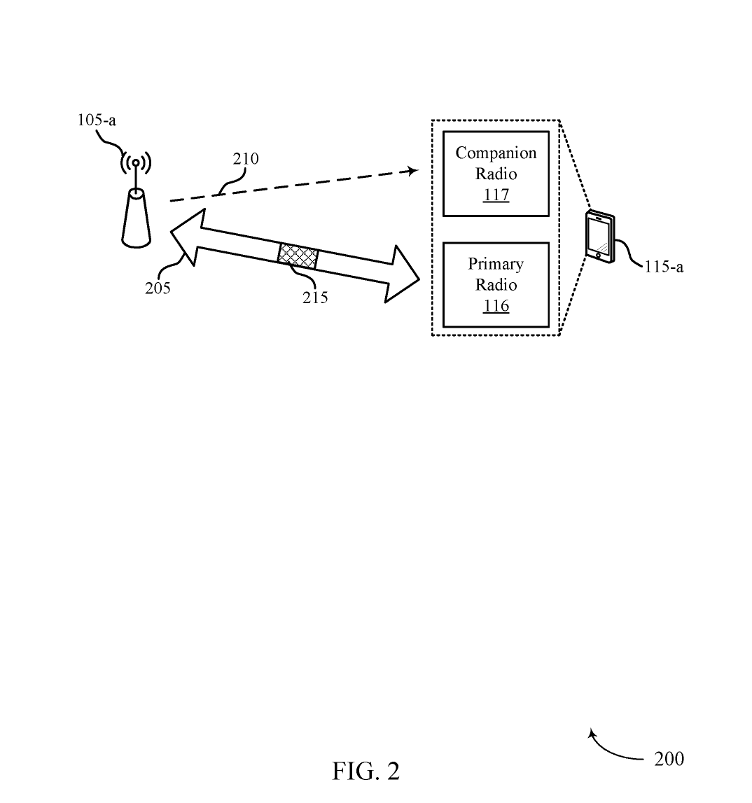

FIG. 2 illustrates an example of a wireless communications system 200 that supports power state management of a wireless device equipped with a WUR in accordance with various aspects of the present disclosure. Wireless communications system 200 may include an AP 105-a and a STA 115-a which may be examples of the corresponding devices described with reference to FIG. 1. STA 115-a may include a primary radio 116 and a companion radio 117 (e.g., a WUR) for communication.

The primary radio 116 may be used during active modes or for high-data throughput applications (e.g., for full power transmissions 205 from AP 105-a). The low-power companion radio 117 may be used during low-power modes or for low-throughput applications (e.g., for wakeup transmissions 210 from AP 105-a). A STA 115 may receive wakeup transmissions and power additional circuitry (e.g., primary radio 116). In some examples, the low-power companion radio 117 may be a WUR. The companion radio 117 may listen for wakeup transmissions 210 (e.g., WUR beacons, WUR transmissions, etc.) and wakeup the primary radio 116 of STA 115-a for primary communications (e.g., full power, high-data throughput applications).

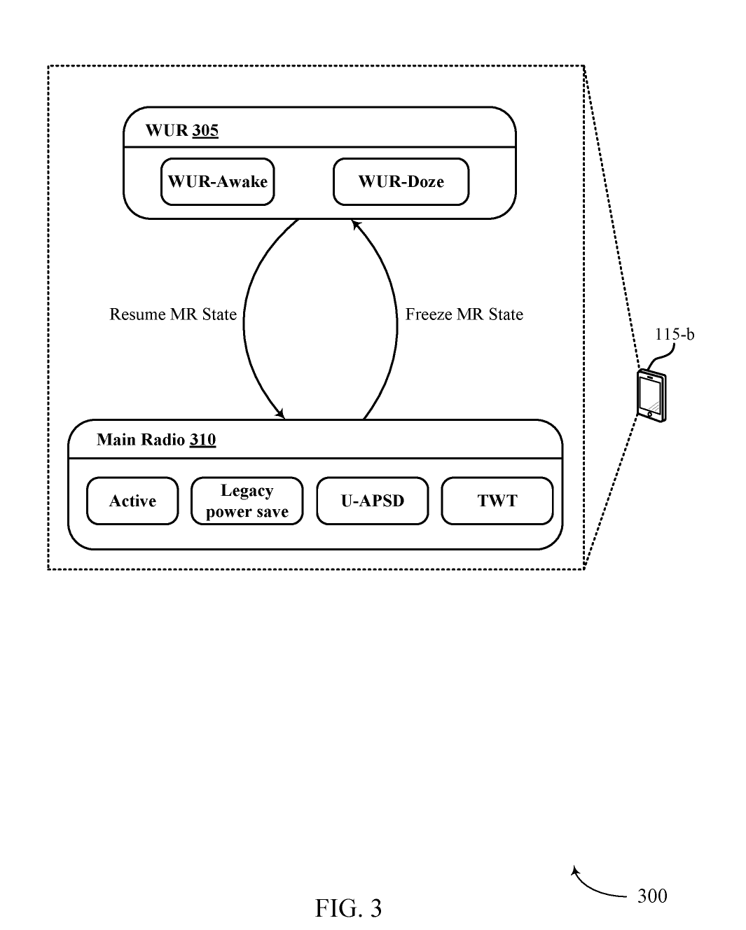

A primary radio 116 (e.g., a main radio, a primary connectivity radio (PCR), etc.) may operate in one of multiple predefined or configured power states (e.g., active state, legacy power save state, U-APSD, etc.). Further, a companion radio 117 (e.g., a WUR) may also operate according to predefined or configured power states (e.g., WUR-Active state, WUR-Doze state, etc.). In some cases, it may be desirable to transition from a primary radio 116 to a companion radio 117 (e.g., to save power). Transitioning to a different radio may further include determining a power state by which to operate the radio. For such transitions, STA 115-a may preserve some or all main radio power states of the primary radio 116 prior to transitioning to a companion radio 117. Upon transitioning back from the companion radio 117 to the primary radio 116, the STA 115-a may operate the primary radio 116 according to the frozen or preserved main radio power state, as further described below with reference to FIG. 3.

In addition to management of power state transitions, STA 115-a may signal transitions from main radio (e.g., primary radio 116) power states to WUR radio (e.g., companion radio 117) power states via uplink frames 215. For example, in cases where STA 115-a transitions from the main radio to the WUR, transition indications (e.g., explicit main radio signaling) may include a newly defined action frame (e.g., such as uplink frames 215) or bits reserved in uplink frames 215 (e.g., piggy-back an indication or toggle bit on existing uplink frames). For example, uplink frames 215 may refer to an acknowledgement (ACK), block acknowledgement (BlockACK), data, action, or management frames, such that some bits reserved in these frames indicate a transition from main radio operation to operation of a WUR. Alternatively, a timeout parameter (e.g., a duration a main radio will stay active without receiving a transmission prior to entering WUR operation) may be negotiated ahead of time (e.g., during STA 115-a and AP 105-a WUR parameter negotiation of duty-cycle, WUR channel, etc.). Such signaling or in advance negotiation may indicate to the AP 105-a when STA 115-a is entering a WUR power save mode.

Further, the AP 105-a may be made aware when STA 115-a transitions back to the main radio by any transmission on the main radio by STA 115-a. For example, if the STA 115-a wakes up (e.g., powers the main radio) on its own merit for a desired uplink transmission (e.g., when STA 115-a desires to transition to the main radio without receiving a wakeup transmission from AP 105-a), the STA 115-a may transmit on the main radio, and the AP 105-a may determine the main radio of STA 115-a is indeed in an active power state. Alternatively, an uplink transmission (e.g., uplink frame 215) may be a newly defined action frame to explicitly indicate to the AP 105-a that STA 115-a is operating the main radio in an active power state.

For example, if STA 115-a is a wireless doorbell (e.g., any client device, an internet of things (IoT) device, etc.), the STA 115-a may wakeup by itself to indicate to AP 105-a that someone has rang the doorbell (e.g., or triggered some threshold). The packet transmission (e.g., an uplink frame 215 indicating a radio transition) may be initiated by STA 115-a, and may indicate to AP 105-a that the STA 115-a has activated the main radio. As discussed above, the packet transmission initiated by STA 115-a may include an explicit main radio activation indication (e.g., a newly defined action frame), any packet transmitted by the STA-a over the main radio, added toggle bits included in predefined transmissions over the main radio, etc.

FIG. 3 illustrates an example of a power state transition scheme 300 that supports power state management of a wireless device equipped with a WUR in accordance with various aspects of the present disclosure. Power state transition scheme 300 may include operations of a STA 115-b, which may represent aspects of techniques performed by a STA 115 as described with reference to FIGS. 1-2. In some cases, power state transition scheme 300 may refer to techniques for transitioning between power states of a main radio 310 (e.g., a primary radio 116) and power states of a WUR 305 (e.g., companion radio 117) as described with reference to FIG. 2.

STA 115-b may include a WUR 305 and a main radio 310, which may each operate according to one or more predefined power states. For example, main radio 310 may operate in an active power state, a legacy power save state, U-APSD power save mode, a TWT power save mode, etc. The operation of the main radio 310 in a particular power state may depend on, for example, power limitations, pending traffic, etc. Further, WUR 305 may operate in WUR-Awake (e.g., a WUR ON state) or a WUR-Doze (a WUR Mode suspend or a WUR OFF state where STA 115-b may turn off or power down the WUR). Transitions between WUR-Awake and WUR-Doze may be performed according to a duty-cycle (e.g., defined by parameters negotiated between an AP 105 and the STA 115-b).

According to techniques described herein, the STA 115-b may freeze a power state associated with the main radio 310 when transitioning from the main radio 310 to the WUR 305. That is, the power state the main radio 310 operates in may be preserved while the main radio 310 enters a deep sleep mode (e.g., while the STA 115-b transitions to using the WUR 305). Upon STA 115-b transitioning back from the WUR 305 to the main radio 310, the main radio 310 may resume the previous power state (e.g., resume operation using the frozen or preserved power state).

For example, STA 115-b may operate the main radio 310 in an active power state. Upon transitioning to a WUR 305, STA 115-b may freeze, or preserve the active power state of the main radio 310. The main radio 310 may enter a deep sleep mode (e.g., may be powered down) as the WUR 305 is powered up (e.g., to operate in a WUR-Awake mode). WUR 305 may then transition between WUR-Active mode and WUR-Doze mode according to a duty-cycle. Once, for example, a wakeup transmission is received (e.g., during a WUR-Active state), STA 115-b may transition from operating the WUR 305 to operating the main radio 310 according to the frozen or preserved active power state (e.g., the STA 115-b may resume a suspended main radio schedule).

As such, STA 115-b may select which power state it would like to resume on the main radio 310 after transitioning back from the WUR 305. That is, the STA 115-b may identify a desirable power state for operation of the main radio 310, and may transition the main radio 310 to the desired power state prior to transition to the WUR 305. Therefore, the desired power state may be frozen or preserved such that upon transition from the WUR 305 back to the main radio 310, the desired power state is resumed. A desired power state for main radio 310 operation post deep sleep (e.g., following WUR 305 operation) may be determined by the STA 115-b (or in some cases, indicated by an AP 105 via prior signaling) as discussed below.

For example, if STA 115-b would like to receive any pending data (e.g., indicated by reception of a wakeup transmission on the WUR 305) as soon as possible, the STA 115-b may transition the main radio 310 to an active power state prior to transitioning to the WUR 305. When STA 115-b transitions back to the main radio 310, the active power state may be resumed, and the STA 115-b may receive traffic indicated by the wakeup transmission as soon as the AP 105 transmits. In such cases, the STA 115-b may notify the AP 105 of the power-on-delay associated with the main radio 310, such that the AP 105 does transmit any pending traffic (e.g., after the wakeup frame) before the STA 115-b has time to activate the main radio 310. The power-on-delay may be indicated during parameter negotiation on the main radio 310 prior to any transitions to the WUR 305. Therefore, if the STA 115-b elects to return to the active power state of the main radio 310 post WUR 305 operation, the AP 105 may start data transmission to the STA 115-b after the power-on-delay associated with the main radio 310.

In other examples, the STA 115-b may desire to transition to a legacy power save state of the main radio 310 post WUR 305 operation. In such cases, when the STA 115-b transitions back to the main radio 310 from the WUR 305, the STA 115-b may transmit a PS poll according to the legacy power save state. Therefore, the AP 105 may receive confirmation that the wakeup transmission was received by the STA 115-b, and that the main radio 310 is active (e.g., versus the previous example where the AP blindly assumes the main radio 310 is active after the negotiated power-on-delay). Further, in cases where the AP 105 transmits a wakeup frame to the WUR 305 to wake up the main radio to later indicate beacon changes (e.g., if AP 105 wants to change the operating channel), the beacon may not come immediately upon activation of the main radio 310. As such, it may be more power efficient for STA 115-b to transition back to the legacy power save state, so that the STA 115-b may wait for the beacon prior to then transitioning to an active state of the main radio (e.g., as indicated by the beacon).

In yet other examples, the STA 115-b may desire to transition to a TWT mode of the main radio 310 post WUR 305 operation (e.g., for prioritized access). If the STA 115-b returns to the frozen or preserved TWT mode after WUR 305 operation, the STA 115-b may receive transmissions from the AP 105 during a time window (e.g., negotiated between STA 115-b and the AP 105) associated with higher priority.

In some cases, STA 115-b may alternatively transition to operation of the main radio according to a main radio power state indicated by the AP 105 via a wakeup frame (e.g., to the STA 115-b WUR while the STA 115-b is employing WUR operation). For example, the AP 105 may indicate a preferred power state (e.g., for STA 115-b main radio operation) via a wakeup frame (e.g., via wakeup transmissions 210). For example, if STA 115-b has preserved a TWT mode for operation after transition out of WUR 305 operation and the AP has urgent or critical data for the STA 115-b, the AP may indicate a main radio active power state via the wakeup transmission, such that the STA 115-b may receive the urgent or critical data as soon as possible (e.g., after the power-on-delay). As such, the STA 115-b may receive the information faster by transitioning to the main radio according to the indicated active power state, than if the STA 115-b returned to the main radio according to the frozen or preserved TWT mode. Alternatively, the STA 115-b may return to the main radio according to the frozen or preserved TWT mode, but then immediately transition the main radio to the indicated active power state (as indicated in the wakeup transmission).

Additionally, STA 115-b may preserve WUR 305 power states for transitions back from the main radio 310 to the WUR 305. For example, STA 115-b may preserve parameters or power state information for WUR operation (e.g., negotiated duty cycle schedule, WUR radio ID assignment and/or group assignment, security keys, etc. may be maintained). The STA 115-b may thus resume the WUR power state during subsequent transitions from main radio 310 operation back to WUR 305 operation. As discussed above, during such transitions from main radio 310 operation back to WUR 305 operation, the existing service period between an AP and the main radio 310 of STA 115-b (e.g., TWT, schedule for network sleep mode, etc.) may be suspended.

As an example, STA 115-b may refer to a wireless door lock. In such cases, STA 115-b may operate a WUR 305 (e.g., in a WUR power save mode) the majority of the time. To reduce power consumption, the STA 115-b may operate the WUR 305 according to a duty-cycle based on negotiated parameters with the AP 105 through the main radio 310. When a user desires to, for example, open a door associated with the wireless door lock (e.g., associated with STA 115-b), the STA 115-b may wake the main radio 310 to receive the user input (e.g., to unlock the door). Subsequently, STA 115-b may desire to return to the WUR power save mode. The STA 115-b may access stored power state information (e.g., duty cycle schedule, WUR radio ID assignment and/or group assignment, security keys, etc.), such that the STA 115-b does not need to renegotiate such parameters with the AP. If STA 115-b would like to use a different WUR power state (e.g., a new duty-cycle schedule, WUR channel, etc.), the STA 115-b may not preserve WUR power state information prior to transition to the main radio 310. In such cases, a new round of WUR parameter negotiation may be performed during operation of the main radio 310 prior to transitioning back to WUR 305 operation.

Techniques described above may apply to all possible transitions (e.g., eight transitions according to the present illustration) between power states of the main radio 310 and power states of the WUR 305. Further, the power states shown are for illustrative purposes only. Additional power states (e.g., of the main radio 310 such as power save multi-poll (PSMP) power states, etc.) may utilize techniques described by analogy, without departing from the scope of the present disclosure.

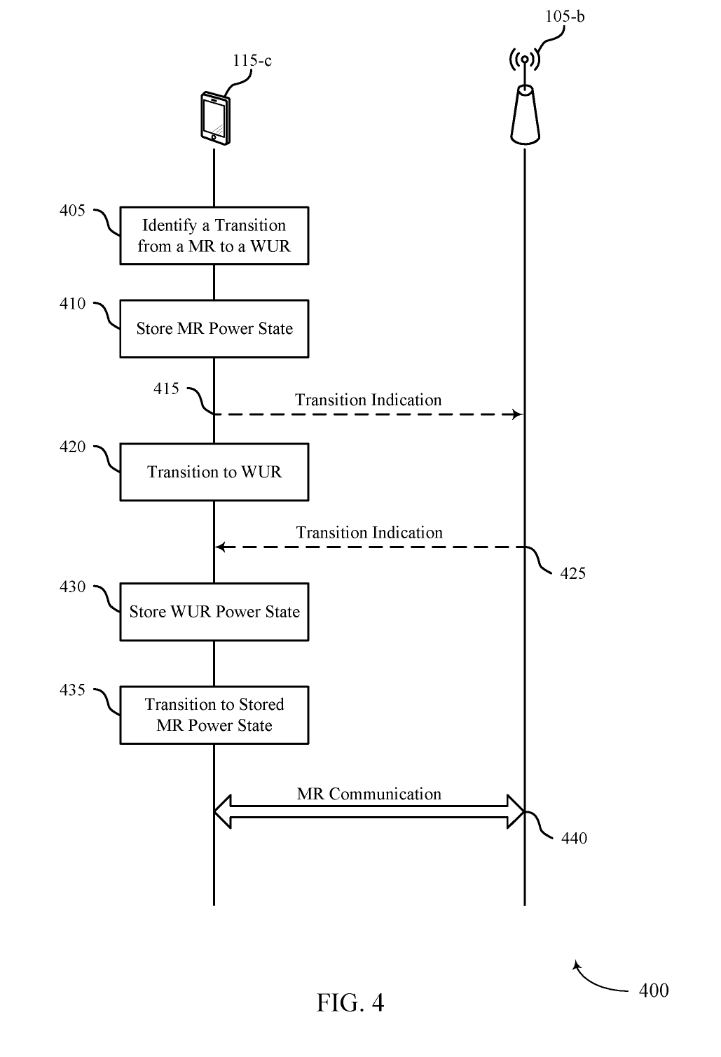

FIG. 4 illustrates an example of a process flow 400 that supports power state management of a wireless device equipped with a WUR in accordance with various aspects of the present disclosure. Process flow 400 may include STA 115-c and AP 105-b, which may be examples of the corresponding devices described with reference to FIGS. 1-3. STA 115-c may include a primary radio 116 (e.g., a main radio (MR)) and a companion radio 117 (e.g., a WUR) for communication.

At step 405, STA 115-c may identify a transition from use of a main radio to use of a WUR is to occur.

At step 410, STA 115-c may store a main radio power state (e.g., an active state, a legacy power save state, a U-APSD power save mode, a TWT power mode, etc.) at the time of the transition from the main radio to the WUR. In some cases, storing the power state of the main radio may include storing one or more of a power mode of the main radio or an operating parameter of the main radio, where the operating parameter includes an indication of an existing service period negotiated between the wireless station and a network.

At step 415, STA 115-c may indicate to AP 105-b that the STA 115-c is transitioning from use of the main radio to use of the WUR. In some cases, the indication may be a transition signal, a transition indication in an uplink frame (e.g., an ACK, a BlockACK, a data frame, an action frame, a management frame, etc.), a single bit reversed in an uplink frame, etc. indicating to AP 105-b that the STA 115-c is to transition from the main radio to a WUR. In some cases, STA 115-c may indicate the transition from use of the main radio to use of the WUR before the STA 115-c stores the main radio power state (e.g., step 415 may occur before step 410).

At step 420, STA 115-c may power down the main radio and power up the WUR to perform the transition identified at step 405. In some cases, powering down the main radio may include suspending the existing service period associated with the main radio of the wireless station. In some cases, the transition to the WUR may be based on a predetermined timeout parameter such that AP 105-b is aware that STA 115-c may undergo the transition to the WUR in accordance to the predetermined timeout parameter. In some cases, the predetermined timeout parameter may be negotiated between the STA 115-c and the AP 105-b in advance of step 405.

At step 425, AP 105-b may transmit an indication for STA 115-c to transition back from use of the WUR to usage of the main radio. In some cases the indication may include a wakeup transmission such as a wakeup frame that includes an indication of a new power state for operation of the main radio. In such cases, the STA 115-b may return to the main radio according to the frozen or preserved power state or mode, but then immediately transition the main radio to the power state as indicated in the wakeup transmission.

At step 430, the STA 115-c may store a WUR power state (e.g., a duty cycle schedule, a wakeup radio channel, a wakeup radio identification assignment, a group assignment, a security key, etc.). In some cases (not shown), the STA 115-c may reenter the stored power state during a subsequent transition back to WUR operation.

At step 435, STA 115-c may power down the WUR and power up the main radio to the power state stored at step 410. In some cases, the transition may be in response to the transition indication received at step 425. In some cases, the STA 115-c may determine a new power state of the main radio for operation (e.g., from an indication received in the wakeup transmission of step 425). In such cases, STA 115-c may power down the WUR and power up the main radio to the newly determined power state.

At step 440, STA 115-c and AP 105-b may communicate via the main radio of STA 115-c. In some cases, communications from AP 105-b may be delayed for a duration associated with a power-on-delay of the main radio of STA 115-c. The power-on-delay may correspond to a time STA 115-c needs to power the main radio, or may correspond to the minimum amount of time between the wakeup transmission of step 425 and a subsequent main radio transmission from AP 105-b. In some cases, STA 115-c may transmit an uplink packet, a transition signal, etc. on the main radio so as to indicate to AP 105-b that STA 115-c has undergone the transition to the main radio.

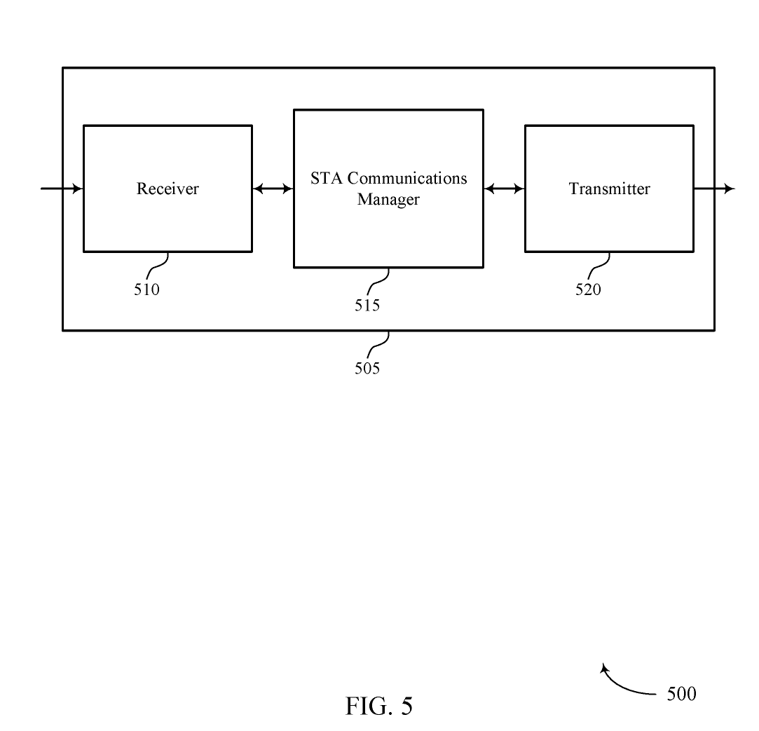

FIG. 5 shows a block diagram 500 of a wireless device 505 that supports power state management of a wireless device equipped with a WUR in accordance with aspects of the present disclosure. Wireless device 505 may be an example of aspects of a STA 115 as described with reference to FIG. 1. Wireless device 505 may include receiver 510, STA communications manager 515, and transmitter 520. Wireless device 505 may also include a processor. Each of these components may be in communication with one another (e.g., via one or more buses).

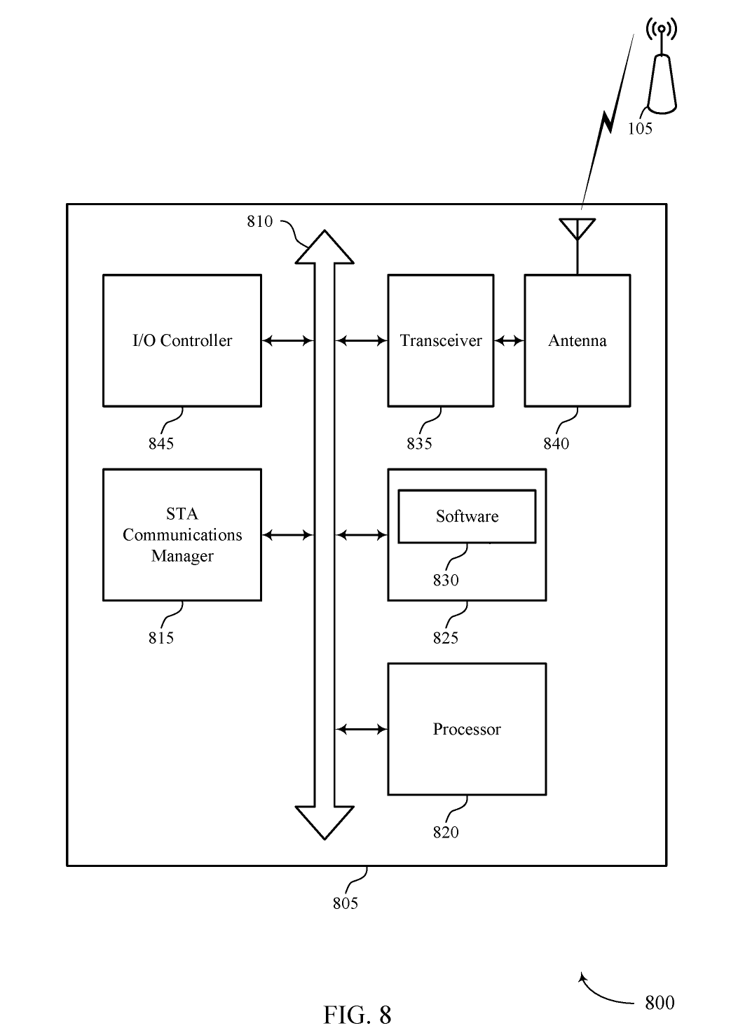

Receiver 510 may receive information such as packets, user data, or control information associated with various information channels (e.g., control channels, data channels, and information related to power state management of a wireless device equipped with a WUR, etc.). Information may be passed on to other components of the device. The receiver 510 may be an example of aspects of the transceiver 835 described with reference to FIG. 8. The receiver 510 may utilize a single antenna or a set of antennas.

STA communications manager 515 may be an example of aspects of the STA communications manager 815 described with reference to FIG. 8. STA communications manager 515 and/or at least some of its various sub-components may be implemented in hardware, software executed by a processor, firmware, or any combination thereof. If implemented in software executed by a processor, the functions of the STA communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The STA communications manager 515 and/or at least some of its various sub-components may be physically located at various positions, including being distributed such that portions of functions are implemented at different physical locations by one or more physical devices. In some examples, STA communications manager 515 and/or at least some of its various sub-components may be a separate and distinct component in accordance with various aspects of the present disclosure. In other examples, STA communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA communications manager 515 may identify that a first transition from use of a main radio of the wireless station (e.g., the wireless device 505) to use of a wakeup radio of the wireless station is to occur. The STA communications manager 515 may store a power state of the main radio at a time of the first transition and power down the main radio and power up the wakeup radio to perform the first transition from use of the main radio to use of the wakeup radio. The STA communications manager 515 may the power up the main radio to the stored power state and power down the wakeup radio to perform a second transition from use of the wakeup radio to use of the main radio. The STA communications manager 515 may also identify that a first transition from use of a main radio of the wireless station to use of a wakeup radio of the wireless station is to occur. The STA communications manager 515 may power down the main radio and power up the wakeup radio to perform the first transition from use of the main radio to use of the wakeup radio. The STA communications manager 515 may then power up the main radio to the stored power state and powering down the wakeup radio to perform a second transition from use of the wakeup radio to use of the main radio, and indicate to an AP that at least one of the first transition or second transition has occurred.

Transmitter 520 may transmit signals generated by other components of the device. In some examples, the transmitter 520 may be collocated with a receiver 510 in a transceiver module. For example, the transmitter 520 may be an example of aspects of the transceiver 835 described with reference to FIG. 8. The transmitter 520 may utilize a single antenna or a set of antennas.

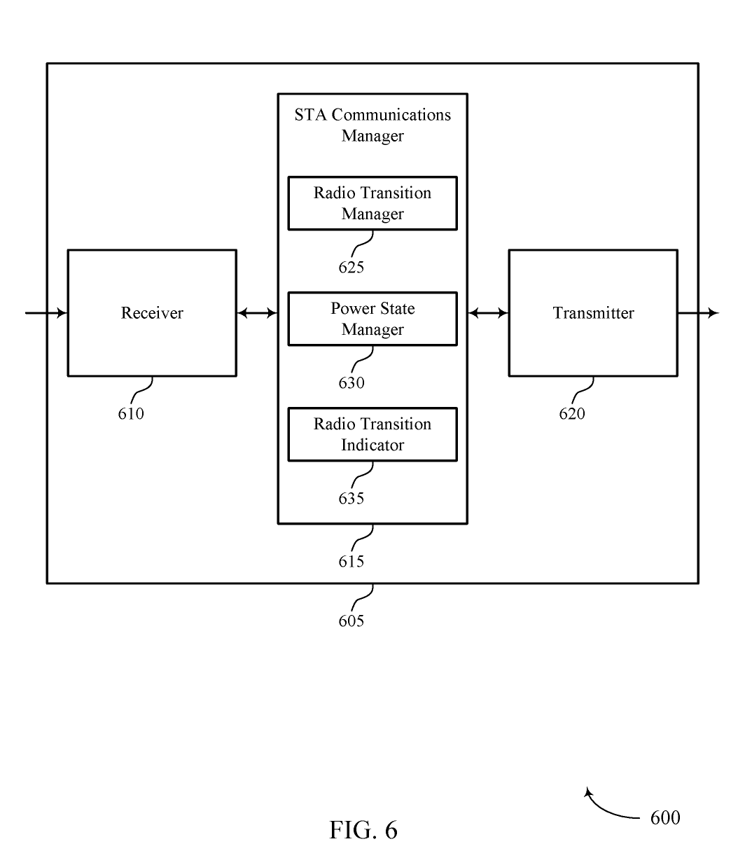

FIG. 6 shows a block diagram 600 of a wireless device 605 that supports power state management of a wireless device equipped with a WUR in accordance with aspects of the present disclosure. Wireless device 605 may be an example of aspects of a wireless device 505 or a STA 115 as described with reference to FIGS. 1 and 5. Wireless device 605 may include receiver 610, STA communications manager 615, and transmitter 620. Wireless device 605 may also include a processor. Each of these components may be in communication with one another (e.g., via one or more buses).

Receiver 610 may receive information such as packets, user data, or control information associated with various information channels (e.g., control channels, data channels, and information related to power state management of a wireless device equipped with a WUR, etc.). Information may be passed on to other components of the device. The receiver 610 may be an example of aspects of the transceiver 835 described with reference to FIG. 8. The receiver 610 may utilize a single antenna or a set of antennas.

STA communications manager 615 may be an example of aspects of the STA communications manager 815 described with reference to FIG. 8. STA communications manager 615 may also include radio transition manager 625, power state manager 630, and radio transition indicator 635.

Radio transition manager 625 may identify that a first transition from use of a main radio of the wireless station (e.g., the wireless device 605) to use of a wakeup radio of the wireless station is to occur, power down the main radio, and power up the wakeup radio to perform the first transition from use of the main radio to use of the wakeup radio. Radio transition manager 625 may power up the main radio to the stored power state and power down the wakeup radio to perform a second transition from use of the wakeup radio to use of the main radio. Radio transition manager 625 may transition the main radio from the stored power state to the new power state after the second transition, power down the main radio, power up the wakeup radio to the stored power state of the wakeup radio to perform a third transition from use of the main radio to use of the wakeup radio.

Power state manager 630 may store a power state of the main radio at a time of the first transition, determine a new power state of the main radio for operation after the second transition, and store a power state of the wakeup radio at the time of the second transition. In some cases, the power state of the wakeup radio includes a duty cycle schedule, a wakeup radio channel, a wakeup radio identification assignment, a group assignment, a security key, or some combination thereof. In some cases, power state manager 630 may store the power state of the main radio by storing one or more of: a power mode of the main radio or an operating parameter of the main radio, where the operating parameter includes an indication of an existing service period negotiated between the wireless station and a network.

Radio transition indicator 635 may transmit a transition signal, a packet, and/or a transition indication so as to indicate to an AP that the wireless station has undergone the first and/or second transition. In some cases, indicating that at least one of the first transition or second transition has occurred includes transmitting a packet, a transition signal, and/or a transition indication in an uplink frame to the AP to indicate that the first and/or second transition has occurred. In some cases, the uplink frame is any one of an acknowledgement, a block acknowledgement, a data frame, an action frame, or a management frame. In some cases, the transition indication is a single bit reserved in the uplink frame for indicating the first transition. In some cases, indicating that at least one of the first transition or second transition has occurred includes negotiating, with the AP, a predetermined timeout parameter such that the AP is aware that the first transition will occur in accordance to the predetermined timeout parameter.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may utilize a single antenna or a set of antennas.

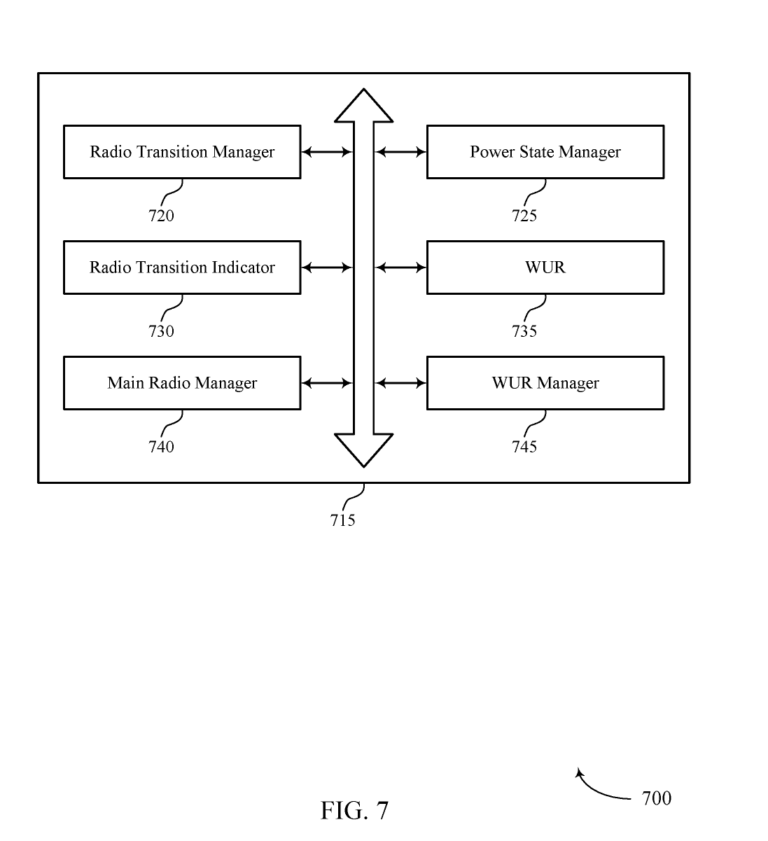

FIG. 7 shows a block diagram 700 of a STA communications manager 715 that supports power state management of a wireless device equipped with a WUR in accordance with aspects of the present disclosure. The STA communications manager 715 may be an example of aspects of a STA communications manager 515, a STA communications manager 615, or a STA communications manager 815 described with reference to FIGS. 5, 6, and 8. The STA communications manager 715 may include radio transition manager 720, power state manager 725, radio transition indicator 730, WUR 735, main radio manager 740, and WUR manager 745. Each of these modules may communicate, directly or indirectly, with one another (e.g., via one or more buses).

Radio transition manager 720 may identify that a first transition from use of a main radio of the wireless station to use of a wakeup radio of the wireless station is to occur, power down the main radio, and power up the wakeup radio to perform the first transition from use of the main radio to use of the wakeup radio. Radio transition manager 720 may power up the main radio to the stored power state and power down the wakeup radio to perform a second transition from use of the wakeup radio to use of the main radio. Radio transition manager 720 may then transition the main radio from the stored power state to the new power state after the second transition, power down the main radio, and power up the wakeup radio to the stored power state of the wakeup radio to perform a third transition from use of the main radio to use of the wakeup radio.

Power state manager 725 may store a power state of the main radio at a time of the first transition and determine a new power state of the main radio for operation after the second transition. In some cases, power state manager 725 may store the power state by suspending an existing service period associated with the main radio. Further, power state manager 725 may store a power state of the wakeup radio at the time of the second transition. In some cases, the power state of the wakeup radio includes a duty cycle schedule, a wakeup radio channel, a wakeup radio identification assignment, a group assignment, a security key, or some combination thereof.

Radio transition indicator 730 may transmit a transition signal, a packet, and/or a transition indication so as to indicate to an AP that the wireless station has undergone the first and/or second transition. In some cases, indicating that at least one of the first transition or second transition has occurred includes transmitting a packet, a transition signal, and/or a transition indication in an uplink frame to the AP to indicate that the first and/or second transition has occurred. In some cases, the uplink frame is any one of an acknowledgement, a block acknowledgement, a data frame, an action frame, or a management frame. In some cases, the transition indication is a single bit reserved in the uplink frame for indicating the first transition. In some cases, indicating that at least one of the first transition or second transition has occurred includes negotiating, with the AP, a predetermined timeout parameter such that the AP is aware that the first transition will occur in accordance to the predetermined timeout parameter.

WUR 735 may receive a wakeup frame to trigger the second transition, where the wakeup frame includes an indication of a new power state of the main radio for operation. In such cases, the STA 115 may return to the main radio according to a frozen or preserved power state, but then immediately transition the main radio to the indicated new power state (as indicated in the wakeup transmission).

Main radio manager 740 may indicate a power-on delay interval to an AP, the power-on delay interval representing a minimum amount of time between transmission of a wakeup frame to the wakeup radio and transmission to the main radio. Main radio manager 740 may then receive a transmission at the main radio from the AP in accordance with the power-on delay interval.

WUR manager 745 may negotiate, with an AP, a predetermined timeout parameter such that the AP is aware that the wireless station will undergo the first transition in accordance to the predetermined timeout parameter.

FIG. 8 shows a diagram of a system 800 including a device 805 that supports power state management of a wireless device equipped with a WUR in accordance with aspects of the present disclosure. Device 805 may be an example of or include the components of wireless device 505, wireless device 605, or a STA 115 as described above, e.g., with reference to FIGS. 1, 5 and 6. Device 805 may include components for bi-directional voice and data communications including components for transmitting and receiving communications, including STA communications manager 815, processor 820, memory 825, software 830, transceiver 835, antenna 840, and I/O controller 845. These components may be in electronic communication via one or more busses (e.g., bus 810).

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting power state management of a wireless device equipped with a WUR).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware and/or software operation such as the interaction with peripheral components or devices.

Software 830 may include code to implement aspects of the present disclosure, including code to support power state management of a wireless device equipped with a WUR. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

I/O controller 845 may manage input and output signals for device 805. I/O controller 845 may also manage peripherals not integrated into device 805. In some cases, I/O controller 845 may represent a physical connection or port to an external peripheral. In some cases, I/O controller 845 may utilize an operating system such as iOS®, ANDROID®, MS-DOS®, MS-WINDOWS®, OS/2®, UNIX®, LINUX®, or another known operating system. In other cases, I/O controller 845 may represent or interact with a modem, a keyboard, a mouse, a touchscreen, or a similar device. In some cases, I/O controller 845 may be implemented as part of a processor. In some cases, a user may interact with device 805 via I/O controller 845 or via hardware components controlled by I/O controller 845.

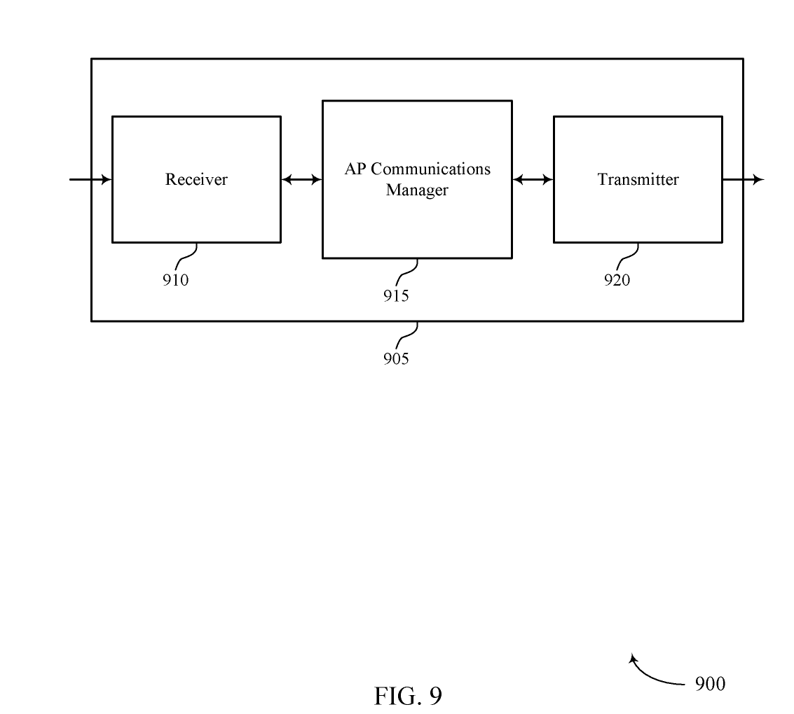

FIG. 9 shows a block diagram 900 of a wireless device 905 that supports power state management of a wireless device equipped with a WUR in accordance with aspects of the present disclosure. Wireless device 905 may be an example of aspects of a AP (AP) 105 as described with reference to FIG. 1. Wireless device 905 may include receiver 910, AP communications manager 915, and transmitter 920. Wireless device 905 may also include a processor. Each of these components may be in communication with one another (e.g., via one or more buses).

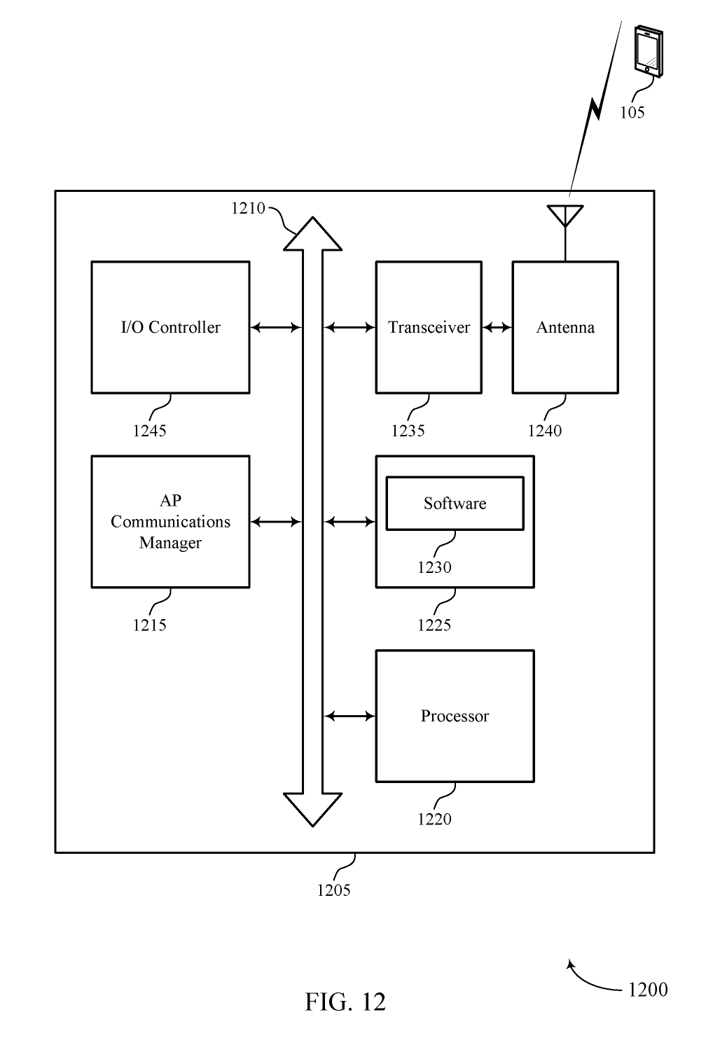

Receiver 910 may receive information such as packets, user data, or control information associated with various information channels (e.g., control channels, data channels, and information related to power state management of a wireless device equipped with a WUR, etc.). Information may be passed on to other components of the device. The receiver 910 may be an example of aspects of the transceiver 1235 described with reference to FIG. 12. The receiver 910 may utilize a single antenna or a set of antennas.

AP communications manager 915 may be an example of aspects of the AP communications manager 1215 described with reference to FIG. 12. AP communications manager 915 and/or at least some of its various sub-components may be implemented in hardware, software executed by a processor, firmware, or any combination thereof. If implemented in software executed by a processor, the functions of the AP communications manager 915 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The AP communications manager 915 and/or at least some of its various sub-components may be physically located at various positions, including being distributed such that portions of functions are implemented at different physical locations by one or more physical devices. In some examples, AP communications manager 915 and/or at least some of its various sub-components may be a separate and distinct component in accordance with various aspects of the present disclosure. In other examples, AP communications manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP communications manager 915 may receive an indication from the wireless station that at least one of a first transition or a second transition has occurred, where the first transition is a powering down of the main radio of the wireless station and a powering up of the wakeup radio of the wireless station, and where the second transition is a powering up of the main radio of the wireless station and a powering down of the wakeup radio of the wireless station and transmit a frame to either the main radio or the wakeup radio, in accordance with the indication.

Transmitter 920 may transmit signals generated by other components of the device. In some examples, the transmitter 920 may be collocated with a receiver 910 in a transceiver module. For example, the transmitter 920 may be an example of aspects of the transceiver 1235 described with reference to FIG. 12. The transmitter 920 may utilize a single antenna or a set of antennas.

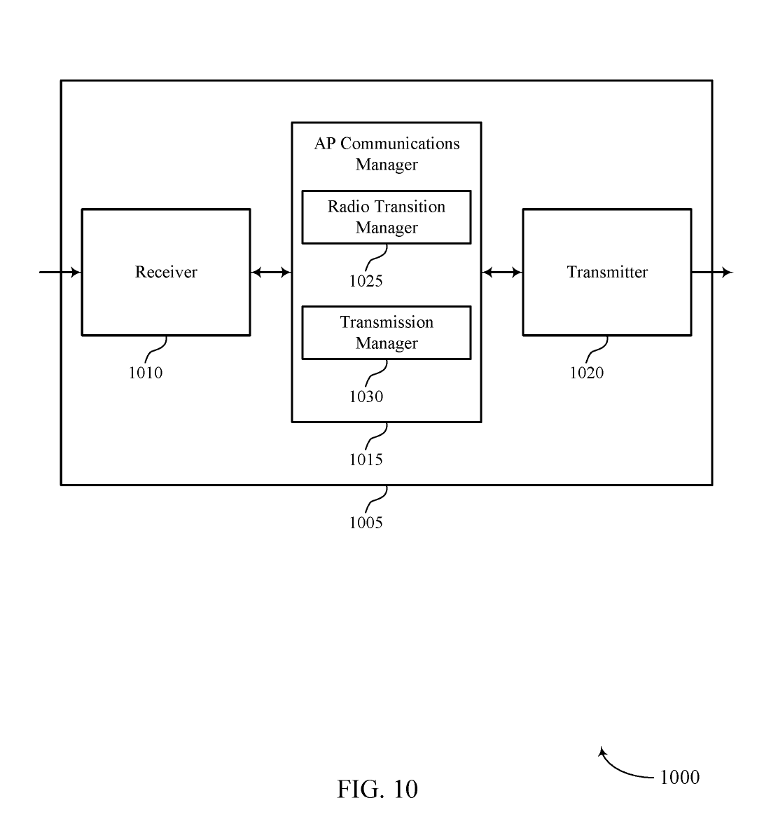

FIG. 10 shows a block diagram 1000 of a wireless device 1005 that supports power state management of a wireless device equipped with a WUR in accordance with aspects of the present disclosure. Wireless device 1005 may be an example of aspects of a wireless device 905 or a AP 105 as described with reference to FIGS. 1 and 9. Wireless device 1005 may include receiver 1010, AP communications manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to power state management of a wireless device equipped with a WUR, etc.). Information may be passed on to other components of the device. The receiver 1010 may be an example of aspects of the transceiver 1235 described with reference to FIG. 12. The receiver 1010 may utilize a single antenna or a set of antennas.

AP communications manager 1015 may be an example of aspects of the AP communications manager 1215 described with reference to FIG. 12. AP communications manager 1015 may also include radio transition manager 1025 and transmission manager 1030.

Radio transition manager 1025 may receive an indication from the wireless station that at least one of a first transition or a second transition has occurred, where the first transition is a powering down of the main radio of the wireless station and a powering up of the wakeup radio of the wireless station, and where the second transition is a powering up of the main radio of the wireless station and a powering down of the wakeup radio of the wireless station. In some cases, receiving the indication that at least one of the first transition or second transition has occurred includes receiving a transition signal indicating that either the first transition or the second transition occurred. In some cases, receiving the indication that at least one of the first transition or second transition has occurred includes receiving a transition indication in an uplink frame indicating that the first transition occurred. In some cases, the uplink frame is any one of an acknowledgement, a block acknowledgement, a data frame, an action frame, or a management frame. In some cases, the transition indication is a single bit reserved in the uplink frame for indicating the first transition. In some cases, receiving the indication that at least one of the first transition or second transition has occurred includes negotiating, with the wireless station, a predetermined timeout parameter such that the AP is aware that the first transition will occur in accordance to the predetermined timeout parameter. In some cases, receiving the indication that at least one of the first transition or second transition has occurred includes receiving a packet from the main radio of the wireless station.

Transmission manager 1030 may transmit a frame to either the main radio or the wakeup radio, in accordance with the indication and transmit a frame to the main radio of the wireless station in accordance to the power-on delay interval indication.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may utilize a single antenna or a set of antennas.

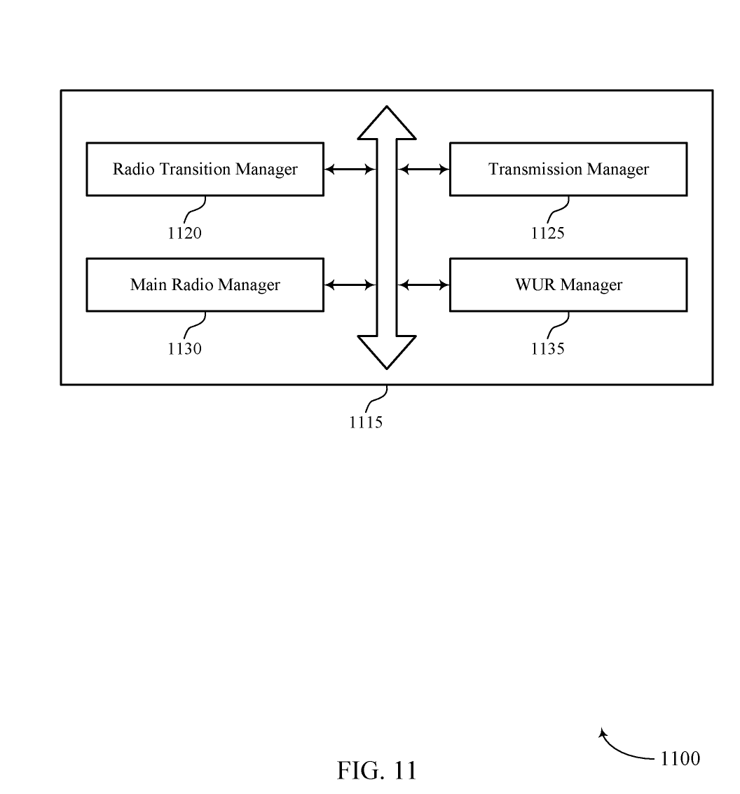

FIG. 11 shows a block diagram 1100 of a AP communications manager 1115 that supports power state management of a wireless device equipped with a WUR in accordance with aspects of the present disclosure. The AP communications manager 1115 may be an example of aspects of a AP communications manager 1215 described with reference to FIGS. 9, 10, and 12. The AP communications manager 1115 may include radio transition manager 1120, transmission manager 1125, main radio manager 1130, and WUR manager 1135. Each of these modules may communicate, directly or indirectly, with one another (e.g., via one or more buses).

Radio transition manager 1120 may receive an indication from the wireless station that at least one of a first transition or a second transition has occurred, where the first transition is a powering down of the main radio of the wireless station and a powering up of the wakeup radio of the wireless station, and where the second transition is a powering up of the main radio of the wireless station and a powering down of the wakeup radio of the wireless station. In some cases, receiving the indication that at least one of the first transition or second transition has occurred includes receiving a transition signal indicating that either the first transition or the second transition occurred. In some cases, receiving the indication that at least one of the first transition or second transition has occurred includes receiving a transition indication in an uplink frame indicating that the first transition occurred. In some cases, the uplink frame is any one of an acknowledgement, a block acknowledgement, a data frame, an action frame, or a management frame. In some cases, the transition indication is a single bit reserved in the uplink frame for indicating the first transition. In some cases, receiving the indication that at least one of the first transition or second transition has occurred includes negotiating, with the wireless station, a predetermined timeout parameter such that the AP is aware that the first transition will occur in accordance to the predetermined timeout parameter. In some cases, receiving the indication that at least one of the first transition or second transition has occurred includes receiving a packet from the main radio of the wireless station.

Transmission manager 1125 may transmit a frame to either the main radio or the wakeup radio, in accordance with the indication and transmit a frame to the main radio of the wireless station in accordance to the power-on delay interval indication.

Main radio manager 1130 may receive a power-on delay interval indication from the wireless station, the power-on delay interval indication representing a minimum amount of time between transmission of a wakeup frame to the wakeup radio of the wireless station and transmission to the main radio of the wireless station.

WUR manager 1135 may transmit a wakeup frame to trigger the second transition, where the wakeup frame includes an indication of a new power state of the main radio for operation to be used by the wireless station.

FIG. 12 shows a diagram of a system 1200 including a device 1205 that supports power state management of a wireless device equipped with a WUR in accordance with aspects of the present disclosure. Device 1205 may be an example of or include the components of AP 105 as described above, e.g., with reference to FIG. 1. Device 1205 may include components for bi-directional voice and data communications including components for transmitting and receiving communications, including AP communications manager 1215, processor 1220, memory 1225, software 1230, transceiver 1235, antenna 1240, and I/O controller 1245. These components may be in electronic communication via one or more busses (e.g., bus 1210).

Processor 1220 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting power state management of a wireless device equipped with a WUR).

Memory 1225 may include RAM and ROM. The memory 1225 may store computer-readable, computer-executable software 1230 including instructions that, when executed, cause the processor to perform various functions described herein. In some cases, the memory 1225 may contain, among other things, a BIOS which may control basic hardware and/or software operation such as the interaction with peripheral components or devices.

Software 1230 may include code to implement aspects of the present disclosure, including code to support power state management of a wireless device equipped with a WUR. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system. In other cases, I/O controller 1245 may represent or interact with a modem, a keyboard, a mouse, a touchscreen, or a similar device. In some cases, I/O controller 1245 may be implemented as part of a processor. In some cases, a user may interact with device 1205 via I/O controller 1245 or via hardware components controlled by I/O controller 1245.

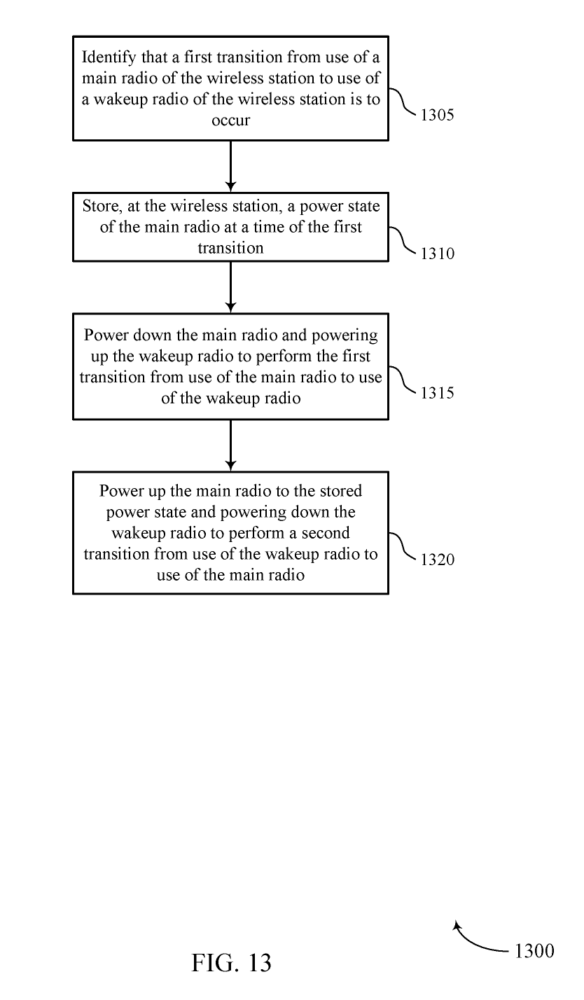

FIG. 13 shows a flowchart illustrating a method 1300 for power state management of a wireless device equipped with a WUR in accordance with aspects of the present disclosure. The operations of method 1300 may be implemented by a STA 115 or its components as described herein. For example, the operations of method 1300 may be performed by a STA communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At block 1305 the STA 115 may identify that a first transition from use of a main radio of the STA 115 to use of a wakeup radio of the STA 115 is to occur. The operations of block 1305 may be performed according to the methods described with reference to FIGS. 1 through 4. In certain examples, aspects of the operations of block 1305 may be performed by a radio transition manager as described with reference to FIGS. 5 through 8.

At block 1310 the STA 115 may store a power state of the main radio at a time of the first transition. The operations of block 1310 may be performed according to the methods described with reference to FIGS. 1 through 4. In certain examples, aspects of the operations of block 1310 may be performed by a power state manager as described with reference to FIGS. 5 through 8.

At block 1315 the STA 115 may power down the main radio and powering up the wakeup radio to perform the first transition from use of the main radio to use of the wakeup radio. The operations of block 1315 may be performed according to the methods described with reference to FIGS. 1 through 4. In certain examples, aspects of the operations of block 1315 may be performed by a radio transition manager as described with reference to FIGS. 5 through 8.

At block 1320 the STA 115 may power up the main radio to the stored power state and powering down the wakeup radio to perform a second transition from use of the wakeup radio to use of the main radio. The operations of block 1320 may be performed according to the methods described with reference to FIGS. 1 through 4. In certain examples, aspects of the operations of block 1320 may be performed by a radio transition manager as described with reference to FIGS. 5 through 8.

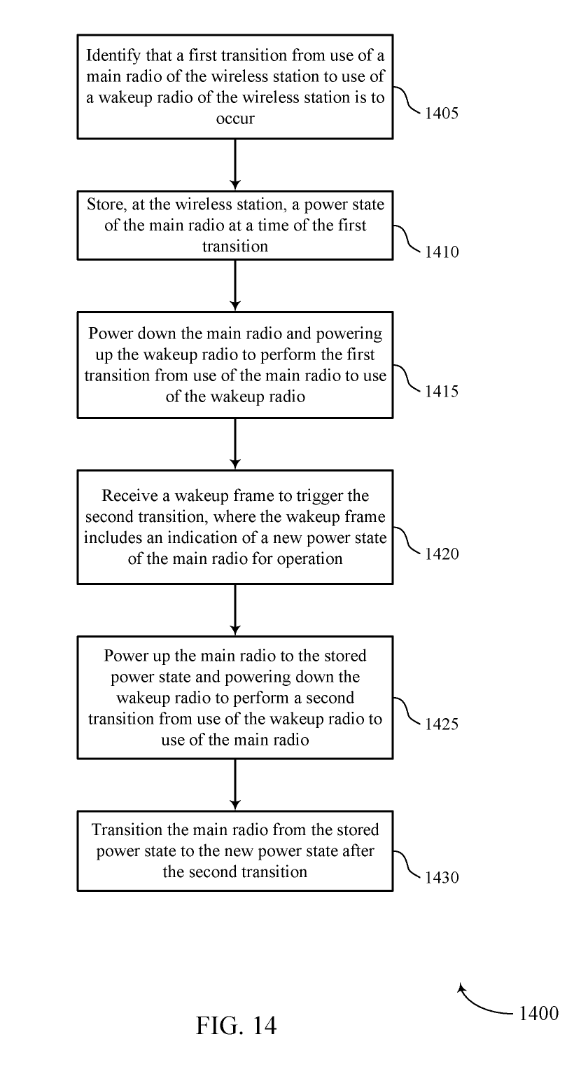

FIG. 14 shows a flowchart illustrating a method 1400 for power state management of a wireless device equipped with a WUR in accordance with aspects of the present disclosure. The operations of method 1400 may be implemented by a STA 115 or its components as described herein. For example, the operations of method 1400 may be performed by a STA communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At block 1405 the STA 115 may identify that a first transition from use of a main radio of the STA 115 to use of a wakeup radio of the STA 115 is to occur. The operations of block 1405 may be performed according to the methods described with reference to FIGS. 1 through 4. In certain examples, aspects of the operations of block 1405 may be performed by a radio transition manager as described with reference to FIGS. 5 through 8.

At block 1410 the STA 115 may store a power state of the main radio at a time of the first transition. The operations of block 1410 may be performed according to the methods described with reference to FIGS. 1 through 4. In certain examples, aspects of the operations of block 1410 may be performed by a power state manager as described with reference to FIGS. 5 through 8.

At block 1415 the STA 115 may power down the main radio and powering up the wakeup radio to perform the first transition from use of the main radio to use of the wakeup radio. The operations of block 1415 may be performed according to the methods described with reference to FIGS. 1 through 4. In certain examples, aspects of the operations of block 1415 may be performed by a radio transition manager as described with reference to FIGS. 5 through 8.

At block 1420 the STA 115 may receive a wakeup frame to trigger the second transition, wherein the wakeup frame includes an indication of a new power state of the main radio for operation. The operations of block 1420 may be performed according to the methods described with reference to FIGS. 1 through 4. In certain examples, aspects of the operations of block 1420 may be performed by a WUR as described with reference to FIGS. 5 through 8.

At block 1425 the STA 115 may power up the main radio to the stored power state and powering down the wakeup radio to perform a second transition from use of the wakeup radio to use of the main radio. The operations of block 1425 may be performed according to the methods described with reference to FIGS. 1 through 4. In certain examples, aspects of the operations of block 1425 may be performed by a radio transition manager as described with reference to FIGS. 5 through 8.

At block 1430 the STA 115 may transition the main radio from the stored power state to the new power state after the second transition. The operations of block 1430 may be performed according to the methods described with reference to FIGS. 1 through 4. In certain examples, aspects of the operations of block 1430 may be performed by a radio transition manager as described with reference to FIGS. 5 through 8.

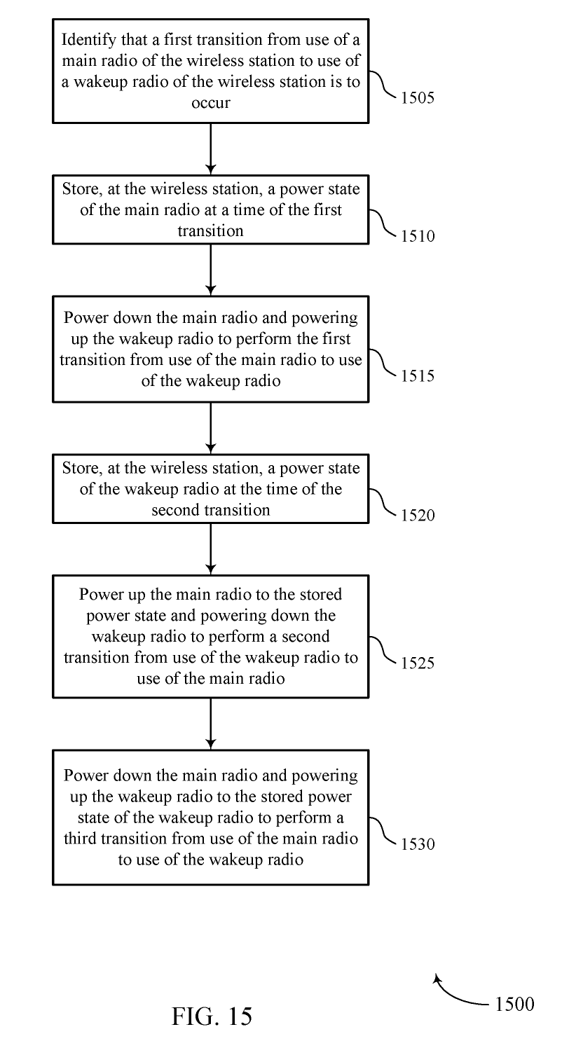

FIG. 15 shows a flowchart illustrating a method 1500 for power state management of a wireless device equipped with a WUR in accordance with aspects of the present disclosure. The operations of method 1500 may be implemented by a STA 115 or its components as described herein. For example, the operations of method 1500 may be performed by a STA communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At block 1505 the STA 115 may identify that a first transition from use of a main radio of the STA 115 to use of a wakeup radio of the STA 115 is to occur. The operations of block 1505 may be performed according to the methods described with reference to FIGS. 1 through 4. In certain examples, aspects of the operations of block 1505 may be performed by a radio transition manager as described with reference to FIGS. 5 through 8.

At block 1510 the STA 115 may store a power state of the main radio at a time of the first transition. The operations of block 1510 may be performed according to the methods described with reference to FIGS. 1 through 4. In certain examples, aspects of the operations of block 1510 may be performed by a power state manager as described with reference to FIGS. 5 through 8.

At block 1515 the STA 115 may power down the main radio and powering up the wakeup radio to perform the first transition from use of the main radio to use of the wakeup radio. The operations of block 1515 may be performed according to the methods described with reference to FIGS. 1 through 4. In certain examples, aspects of the operations of block 1515 may be performed by a radio transition manager as described with reference to FIGS. 5 through 8.

At block 1520 the STA 115 may store a power state of the wakeup radio at the time of the second transition. The operations of block 1520 may be performed according to the methods described with reference to FIGS. 1 through 4. In certain examples, aspects of the operations of block 1520 may be performed by a power state manager as described with reference to FIGS. 5 through 8.

At block 1525 the STA 115 may power up the main radio to the stored power state and powering down the wakeup radio to perform a second transition from use of the wakeup radio to use of the main radio. The operations of block 1525 may be performed according to the methods described with reference to FIGS. 1 through 4. In certain examples, aspects of the operations of block 1525 may be performed by a radio transition manager as described with reference to FIGS. 5 through 8.

At block 1530 the STA 115 may power down the main radio and powering up the wakeup radio to the stored power state of the wakeup radio to perform a third transition from use of the main radio to use of the wakeup radio. The operations of block 1530 may be performed according to the methods described with reference to FIGS. 1 through 4. In certain examples, aspects of the operations of block 1530 may be performed by a radio transition manager as described with reference to FIGS. 5 through 8.

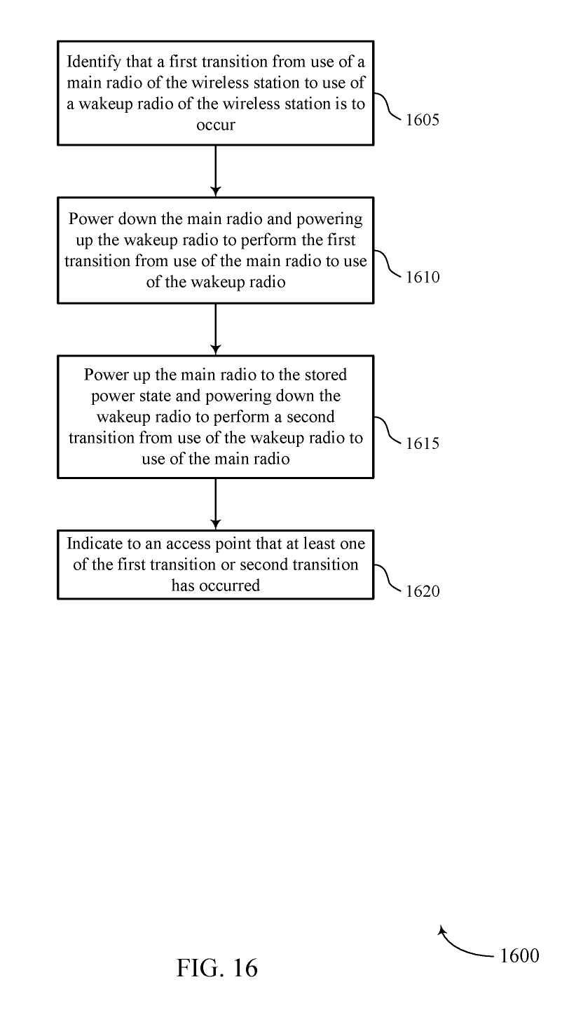

FIG. 16 shows a flowchart illustrating a method 1600 for power state management of a wireless device equipped with a WUR in accordance with aspects of the present disclosure. The operations of method 1600 may be implemented by a STA 115 or its components as described herein. For example, the operations of method 1600 may be performed by a STA communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At block 1605 the STA 115 may identify that a first transition from use of a main radio of the STA 115 to use of a wakeup radio of the STA 115 is to occur. The operations of block 1605 may be performed according to the methods described with reference to FIGS. 1 through 4. In certain examples, aspects of the operations of block 1605 may be performed by a radio transition manager as described with reference to FIGS. 5 through 8.

At block 1610 the STA 115 may power down the main radio and powering up the wakeup radio to perform the first transition from use of the main radio to use of the wakeup radio. The operations of block 1610 may be performed according to the methods described with reference to FIGS. 1 through 4. In certain examples, aspects of the operations of block 1610 may be performed by a radio transition manager as described with reference to FIGS. 5 through 8.

At block 1615 the STA 115 may power up the main radio to the stored power state and powering down the wakeup radio to perform a second transition from use of the wakeup radio to use of the main radio. The operations of block 1615 may be performed according to the methods described with reference to FIGS. 1 through 4. In certain examples, aspects of the operations of block 1615 may be performed by a radio transition manager as described with reference to FIGS. 5 through 8.

At block 1620 the STA 115 may indicate to an AP that at least one of the first transition or second transition has occurred. The operations of block 1620 may be performed according to the methods described with reference to FIGS. 1 through 4. In certain examples, aspects of the operations of block 1620 may be performed by a radio transition indicator as described with reference to FIGS. 5 through 8.

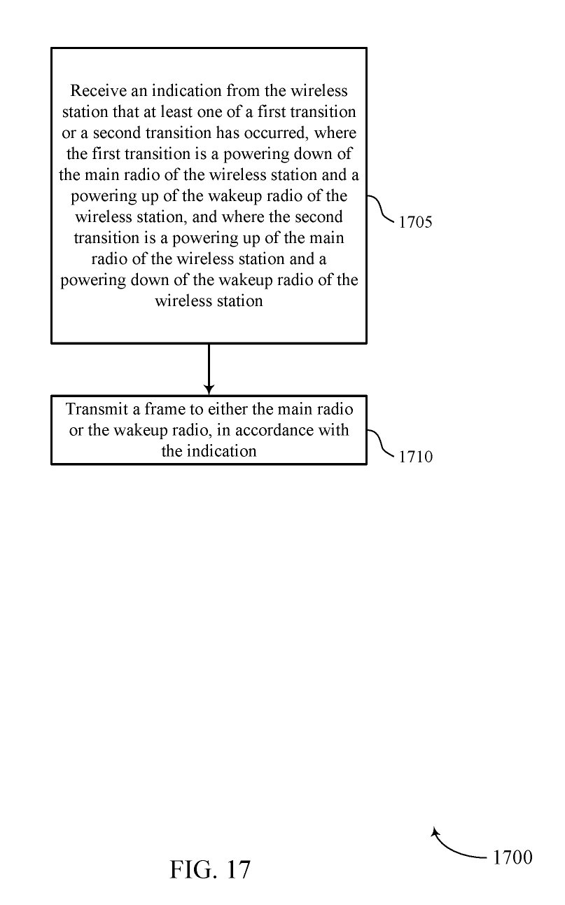

FIG. 17 shows a flowchart illustrating a method 1700 for power state management of a wireless device equipped with a WUR in accordance with aspects of the present disclosure. The operations of method 1700 may be implemented by a AP 105 or its components as described herein. For example, the operations of method 1700 may be performed by a AP communications manager as described with reference to FIGS. 9 through 12. In some examples, a AP 105 may execute a set of codes to control the functional elements of the device to perform the functions described below. Additionally or alternatively, the AP 105 may perform aspects of the functions described below using special-purpose hardware.

At block 1705 the AP 105 may receive an indication from the wireless station that at least one of a first transition or a second transition has occurred, wherein the first transition is a powering down of the main radio of the wireless station and a powering up of the wakeup radio of the wireless station, and wherein the second transition is a powering up of the main radio of the wireless station and a powering down of the wakeup radio of the wireless station. The operations of block 1705 may be performed according to the methods described with reference to FIGS. 1 through 4. In certain examples, aspects of the operations of block 1705 may be performed by a radio transition manager as described with reference to FIGS. 9 through 12.

At block 1710 the AP 105 may transmit a frame to either the main radio or the wakeup radio, in accordance with the indication. The operations of block 1710 may be performed according to the methods described with reference to FIGS. 1 through 4. In certain examples, aspects of the operations of block 1710 may be performed by a transmission manager as described with reference to FIGS. 9 through 12.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for operation of a wireless station, comprising:
identifying that a first transition from use of a main radio of the wireless station to use of a wakeup radio of the wireless station is to occur;
storing, at the wireless station, a power state of the main radio at a time of the first transition;
powering down the main radio and powering up the wakeup radio to perform the first transition from use of the main radio to use of the wakeup radio; and
powering up the main radio to the stored power state and powering down the wakeup radio to perform a second transition from use of the wakeup radio to use of the main radio.

2. The method of claim 1, further comprising:
determining a new power state of the main radio for operation after the second transition.

3. The method of claim 1, further comprising:
receiving a wakeup frame to trigger the second transition, wherein the wakeup frame includes an indication of a new power state of the main radio for operation; and
transitioning the main radio from the stored power state to the new power state after the second transition.

4. The method of claim 1, further comprising:
indicating a power-on delay interval to an access point, the power-on delay interval representing a minimum amount of time between transmission, by the access point, of a wakeup frame to the wakeup radio and transmission, by the access point, to the main radio.

5. The method of claim 1, further comprising:
transmitting, by the main radio, a transition signal to an access point in order to indicate to the access point that the wireless station is to undergo the first transition.

6. The method of claim 1, further comprising:
transmitting, by the main radio, a transition indication in an uplink frame to an access point, the transition indication indicating to the access point that the wireless station is to undergo the first transition.

7. The method of claim 6, wherein:
the uplink frame is any one of an acknowledgement, a block acknowledgement, a data frame, an action frame, or a management frame.

8. The method of claim 6, wherein:
the transition indication is a single bit reserved in the uplink frame for indicating the first transition.

9. The method of claim 1, further comprising:
negotiating, with an access point, a predetermined timeout parameter such that the access point is aware that the wireless station will undergo the first transition in accordance to the predetermined timeout parameter.

10. The method of claim 1, further comprising:
transmitting, by the main radio, a packet so as to indicate to an access point that the wireless station has undergone the second transition.

11. The method of claim 1, further comprising:
transmitting, by the main radio, a transition signal to an access point in order to indicate to the access point that the wireless station has undergone the second transition.

12. The method of claim 1, further comprising:
storing, at the wireless station, a power state of the wakeup radio at the time of the second transition; and
powering down the main radio and powering up the wakeup radio to the stored power state of the wakeup radio to perform a third transition from use of the main radio to use of the wakeup radio.

13. The method of claim 12, wherein:
the power state of the wakeup radio comprises a duty cycle schedule, a wakeup radio channel, a wakeup radio identification assignment, a group assignment, a security key, or some combination thereof.

14. The method of claim 1, wherein:
storing the power state of the main radio at the time of the first transition comprises storing one or more of: a power mode of the main radio or an operating parameter of the main radio, wherein the operating parameter includes an indication of an existing service period negotiated between the wireless station and a network; and
powering down the main radio comprises suspending the existing service period associated with the main radio of the wireless station.

15. An apparatus for operation of a wireless station, comprising:
a processor;
memory in electronic communication with the processor; and
instructions stored in the memory and operable, when executed by the processor, to cause the apparatus to:
identify that a first transition from use of a main radio of the wireless station to use of a wakeup radio of the wireless station is to occur;
store, at the wireless station, a power state of the main radio at a time of the first transition;
power down the main radio and powering up the wakeup radio to perform the first transition from use of the main radio to use of the wakeup radio; and
power up the main radio to the stored power state and powering down the wakeup radio to perform a second transition from use of the wakeup radio to use of the main radio.

16. The apparatus of claim 15, wherein the instructions are further executable by the processor to:
determine a new power state of the main radio for operation after the second transition.

17. The apparatus of claim 15, wherein the instructions are further executable by the processor to:
receive a wakeup frame to trigger the second transition, wherein the wakeup frame includes an indication of a new power state of the main radio for operation; and
transition the main radio from the stored power state to the new power state after the second transition.

18. The apparatus of claim 15, wherein the instructions are further executable by the processor to:
indicate a power-on delay interval to an access point, the power-on delay interval representing a minimum amount of time between transmission, by the access point, of a wakeup frame to the wakeup radio and transmission, by the access point, to the main radio.

19. The apparatus of claim 15, wherein the instructions are further executable by the processor to:
transmit, by the main radio, a transition signal to an access point in order to indicate to the access point that the wireless station is to undergo the first transition.

20. The apparatus of claim 15, wherein the instructions are further executable by the processor to:
transmit, by the main radio, a transition indication in an uplink frame to an access point, the transition indication indicating to the access point that the wireless station is to undergo the first transition.

21. The apparatus of claim 20, wherein:
the uplink frame is any one of an acknowledgement, a block acknowledgement, a data frame, an action frame, or a management frame.

22. The apparatus of claim 20, wherein:
the transition indication is a single bit reserved in the uplink frame for indicating the first transition.

23. The apparatus of claim 15, wherein the instructions are further executable by the processor to:
negotiate, with an access point, a predetermined timeout parameter such that the access point is aware that the wireless station will undergo the first transition in accordance to the predetermined timeout parameter.

24. The apparatus of claim 15, wherein the instructions are further executable by the processor to:
transmit, by the main radio, a packet so as to indicate to an access point that the wireless station has undergone the second transition.

25. The apparatus of claim 15, wherein the instructions are further executable by the processor to:
transmit, by the main radio, a transition signal to an access point in order to indicate to the access point that the wireless station has undergone the second transition.

26. The apparatus of claim 15, wherein the instructions are further executable by the processor to:
store, at the wireless station, a power state of the wakeup radio at the time of the second transition; and
power down the main radio and powering up the wakeup radio to the stored power state of the wakeup radio to perform a third transition from use of the main radio to use of the wakeup radio.

27. The apparatus of claim 26, wherein:
the power state of the wakeup radio comprises a duty cycle schedule, a wakeup radio channel, a wakeup radio identification assignment, a group assignment, a security key, or some combination thereof.

28. The apparatus of claim 15, wherein:
the instructions executable by the processor to store the power state of the main radio at the time of the first transition comprise instructions executable by the processor to store one or more of: a power mode of the main radio or an operating parameter of the main radio, wherein the operating parameter includes an indication of an existing service period negotiated between the wireless station and a network; and
the instructions executable by the processor to power down the main radio comprise instructions executable by the processor to suspend an existing service period associated with the main radio of the wireless station.

29. A non-transitory computer readable medium storing code for operation of a wireless station, the code comprising instructions executable by a processor to:
identify that a first transition from use of a main radio of the wireless station to use of a wakeup radio of the wireless station is to occur;
store, at the wireless station, a power state of the main radio at a time of the first transition;
power down the main radio and powering up the wakeup radio to perform the first transition from use of the main radio to use of the wakeup radio; and
power up the main radio to the stored power state and powering down the wakeup radio to perform a second transition from use of the wakeup radio to use of the main radio.

30. An apparatus for operation of a wireless station, comprising:
means for identifying that a first transition from use of a main radio of the wireless station to use of a wakeup radio of the wireless station is to occur;
means for storing, at the wireless station, a power state of the main radio at a time of the first transition;
means for powering down the main radio and powering up the wakeup radio to perform the first transition from use of the main radio to use of the wakeup radio; and
means for powering up the main radio to the stored power state and powering down the wakeup radio to perform a second transition from use of the wakeup radio to use of the main radio.
